(19) United States
(12) Patent Application Publication
(10) Pub. No.: US 2024/0312181 A1
(43) Pub. Date: Sep. 19, 2024

(54) VIDEO DETECTION METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventor: Dazhi LUO, Shenzhen (CN)

(21) Appl. No.: 18/674,461

(22) Filed: May 24, 2024

Related U.S. Application Data
(63) Continuation of application No. PCT/CN2023/082240, filed on Mar. 17, 2023.

(30) Foreign Application Priority Data
May 19, 2022 (CN) 202210545281.3

(51) Int. Cl. G06V 10/762; G06V 10/25; G06V 10/764; G06V 10/771; G06V 20/40

(52) U.S. Cl. CPC G06V 10/762; G06V 10/25; G06V 10/764; G06V 10/771; G06V 20/49

(57) ABSTRACT

In a video detection method, a video frame sequence corresponding to a target video is acquired, a frosted glass detection is sequentially performed on each video frame in the video frame sequence by using a trained frosted glass region detection model, and a target video frame that includes a frosted glass region in the video frame sequence and a position of the frosted glass region in the target video frame are obtained, consecutive target video frames are further clustered according to an overlapping degree between positions of frosted glass regions, to obtain a plurality of consecutive target video clips; and respective start and stop time of the plurality of consecutive target video clips in the target video and the positions of the frosted glass regions may be outputted.

### CROSS-REFERENCES RELATED APPLICATIONS

This application is a continuation application of PCT Patent Application No. PCT/CN2023/082240, filed on Mar. 17, 2023, which claims priority to Chinese Patent Application No. 202210545281.3, entitled “VIDEO DETECTION METHOD AND APPARATUS, DEVICE, STORAGE MEDIUM, AND PROGRAM PRODUCT” filed with the China National Intellectual Property Administration on May 19, 2022, which are incorporated herein by reference in their entirety.

### FIELD OF THE TECHNOLOGY

The present disclosure relates to the field of computer processing technologies, and in particular, to a video detection method and apparatus thereof, a computer device, a storage medium, and a computer program product, and further to a method for training a frosted glass region detection model and an apparatus thereof, a computer device, a storage medium, and a computer program product.

### BACKGROUND OF THE DISCLOSURE

With the rapid development of computer technologies and the in-depth study of machine learning technologies, machine learning-based video detection tasks are widely applied. A video detection task is a process of detecting a target in a video, and can play an important role in scenarios such as security maintenance based on videos, video copyright protection, and video deduplication detection.

For example, it is a common malicious behavior to repost other people's videos without permission. A plagiarizing account usually adds a frosted glass effect to a video or uses various other manners to form a difference from an original video. In another example, some accounts spread non-compliant videos by adding a frosted glass effect to block or blur key information, and the like. It is necessary to detect a frosted glass region in a video to discover these cases.

A frosted glass region in a video is generally detected based on gradient or variance information of images. It is only possible to obtain a detection result about whether a frosted glass region exists in a video, and an intuitive frosted glass region identification cannot be outputted for a video, resulting in a poor detection effect.

### SUMMARY

A video detection method is provided, the method including: acquiring a video frame sequence corresponding to a target video; sequentially performing a frosted glass detection on each video frame in the video frame sequence by using a trained frosted glass region detection model, and obtaining a target video frame that includes a frosted glass region in the video frame sequence and a position of the frosted glass region in the target video frame; clustering consecutive target video frames in the target video according to an overlapping degree between positions of frosted glass regions, to obtain a plurality of consecutive target video clips; and outputting respective start and stop time of the plurality of consecutive target video clips in the target video and the positions of the frosted glass regions.

A video detection apparatus is provided, the apparatus including: a video frame acquisition module, configured to acquire a video frame sequence corresponding to a target video; a frosted glass detection module, configured to: sequentially perform a frosted glass detection on each video frame in the video frame sequence by using a trained frosted glass region detection model, and obtain a target video frame that includes a frosted glass region in the video frame sequence and a position of the frosted glass region in the target video frame; a clustering module, configured to cluster consecutive target video frames in the target video according to an overlapping degree between positions of frosted glass regions, to obtain a plurality of consecutive target video clips; and an output module, configured to output respective start and stop time of the plurality of consecutive target video clips in the target video and the positions of the frosted glass regions.

A computer device is provided, including a memory and a processor, the memory storing computer-readable instructions, the processor performing the foregoing video detection method.

A non-transitory computer-readable storage medium is provided, having computer-readable instructions stored therein, when executed by a processor, the computer-readable instructions performing the foregoing video detection method.

A method for training a frosted glass region detection model is provided, the method including: performing a supervised training on a frosted glass region detection model by using an annotated training sample set to obtain an initial model; acquiring an unannotated training sample set, performing a prediction on an unannotated training sample in the unannotated training sample set and a corresponding augmented training sample by using the initial model respectively, acquiring respective prediction results, and obtaining a consistency loss based on a difference between the respective prediction results of the unannotated training sample and the corresponding augmented training sample; and performing a joint training on the initial model based on a labeled training loss of an annotated training sample and the consistency loss, to obtain a trained frosted glass region detection model.

An apparatus for training a frosted glass region detection model is provided, the apparatus including: a supervised training module, configured to perform a supervised training on a frosted glass region detection model by using an annotated training sample set to obtain an initial model; an unlabeled loss acquisition module, configured to: acquire an unannotated training sample set, perform a prediction on an unannotated training sample in the unannotated training sample set and a corresponding augmented training sample by using the initial model respectively, acquire respective prediction results, and obtain a consistency loss based on a difference between the respective prediction results of the unannotated training sample and the corresponding augmented training sample; and a joint training module, configured to perform a joint training on the initial model based on a labeled training loss of an annotated training sample and the consistency loss, to obtain a trained frosted glass region detection model.

A computer device is provided, including a memory and a processor, the memory storing computer-readable instructions, the processor performing the foregoing method for training a frosted glass region detection model.

A non-transitory computer-readable storage medium is provided, having computer-readable instructions stored therein, when executed by a processor, the computer-readable instructions performing the foregoing method for training a frosted glass region detection model.

### BRIEF DESCRIPTION OF THE DRAWINGS

Accompanying drawings herein are incorporated into the specification and constitute a part of this specification, show embodiments that conform to the present disclosure, and are used for describing a principle of the present disclosure together with this specification. Apparently, the accompanying drawings in the following descriptions are merely some embodiments of the present disclosure.

FIG. 1 is a diagram showing an application environment of a video detection method or a method for training a frosted glass region detection model in an embodiment;

FIG. 2 is a schematic flowchart of a video detection method in an embodiment;

FIG. 3 is a schematic flowchart of acquiring a video frame sequence in an embodiment;

FIG. 4 is a schematic diagram of an effect of a frosted glass region detection in an embodiment;

FIG. 5 is a schematic composition diagram of units in an embodiment;

FIG. 6 is a schematic composition diagram of a frosted glass region detection model in an embodiment;

FIG. 7 is a schematic diagram of a role of an anchor structure in an embodiment;

FIG. 8 is a schematic flowchart of obtaining an annotated training sample in an annotation manner in an embodiment;

FIG. 9 is a schematic diagram of an annotation process in an embodiment;

FIG. 10 is a schematic diagram of annotation data in an embodiment;

FIG. 11 is a schematic diagram of types used in a frosted glass simulated embedding in an embodiment;

FIG. 12 is a schematic diagram of adjusting a text color in an embodiment;

FIG. 13 is a schematic flowchart of class balancing in an embodiment;

FIG. 14 is a schematic diagram of a semi-supervised training framework in an embodiment;

FIG. 15 is a schematic diagram of learning rate decay in an embodiment;

FIG. 16 is a schematic flowchart of a method for training a frosted glass region detection model in an embodiment;

FIG. 17 is a schematic diagram of a video detection framework in an embodiment;

FIG. 18 is a schematic diagram of a training sample source used in semi-supervised training in an embodiment;

FIG. 19 is a structural block diagram of a video detection apparatus in an embodiment;

FIG. 20 is a structural block diagram of an apparatus for training a frosted glass region detection model in an embodiment; and

FIG. 21 is a diagram of an internal structure of a computer device in an embodiment.

### DESCRIPTION OF EMBODIMENTS

To make the objectives, technical solutions, and advantages of the present disclosure clearer and more comprehensible, the present disclosure is further elaborated in detail with reference to the accompanying drawings and embodiments. The specific embodiments described herein are merely used for explaining the present disclosure but are not intended to limit the present disclosure.

Embodiment mentioned in the present disclosure means that particular features, structures, or characteristics described with reference to the embodiment may be included in at least one embodiment of the present disclosure. The occurrence of the phrase at various locations in the specification does not necessarily refer to the same embodiment, nor is it a separate embodiment or an alternative embodiment that is mutually exclusive with other embodiments. A person skilled in the art explicitly or implicitly understands that the embodiments described in the present disclosure may be combined with other embodiments. The terms “first”, “second”, and so on described in the present disclosure are intended to distinguish similar objects but do not necessarily indicate a specific order or sequence.

Solutions provided in embodiments of the present disclosure relate to a technology of detecting frosted glass in a video using artificial intelligence. Some terms used in the embodiments of the present disclosure are first described below:

Frosted glass: Frosted glass is a blurred effect or a translucent effect obtained by performing a global or local rendering on an image or a video.

Frosted glass detection: A frosted glass detection is a detection of a region in an image or a video that has a frosted glass effect/texture. When it is detected that a frosted glass region exists, a position of the frosted glass region needs to be acquired.

Video deduplication: A video deduplication is a duplicate detection step performed by a video platform on a video posted on the video platform, to prevent the posted video from infringing another person's copyright.

Video: A video is essentially formed by still pictures. These still pictures are referred to as frames.

Video frame: For video frames, a frame rate is a measure for measuring a quantity of displayed frames. A measurement unit is frames per second (FPS) or “Hertz” (Hz).

CNN (Convolutional neural network): CNN is short for convolutional neural network.

Supervised training: A supervised training is a machine learning task for deducing a function from an annotated training sample set.

Unsupervised training: An unsupervised training solves various problems in mode recognition according to an unannotated training sample set.

Semi-supervised training: A semi-supervised training may be referred to as a joint training, in which mode recognition work is performed by joining a large number of unannotated training samples and a small number of annotated training samples.

MSE (Mean Square Error): A mean square error is a calculated mean value of a square sum of errors of points corresponding to predicted data and original data.

CDRLR (Cosine Decay Restarts Learning Rate): A CDRLR is a learning rate decay strategy.

Accuracy rate: An accuracy rate is an indicator for evaluating a classification effect. When the score is higher, the effect is better.

Precision rate: A precision rate is an indicator for evaluating a classification effect. When the score is higher, the effect is better.

Recall rate: A recall rate is an indicator for evaluating a classification effect. When the score is higher, the effect is better.

A frosted glass detection scheme is generally performed based on image gradient or variance information. It is determined, by analyzing whether an image gradient or variance is greater than a fixed threshold, whether a frosted glass region exists in an image. This scheme depends on the setting of the fixed threshold. Frosted glass with different blurring degrees is prone to a detection miss or an incorrect determination. In addition, through this scheme, it can only be provided whether a frosted glass region exists in an image, but it is difficult to provide a position of the frosted glass region.

For a video detection scheme provided in the present disclosure, related embodiments may be widely applied to scenarios such as copyright management, copyright protection, video infringement management, infringement prevention, video security, and copyright security maintenance. In a video detection process, a detection is performed by using a trained frosted glass region detection model. Because the frosted glass region detection model is obtained through training, a lot of knowledge related to frosted glass regions is learned. In this way, for frosted glass with different blurring degrees, detection misses or incorrect determinations can be minimized. In addition, the frosted glass region detection model provides whether a frosted glass region exists in a video frame, and further provides a position of the frosted glass region, so that the precision of a frosted glass detection is improved.

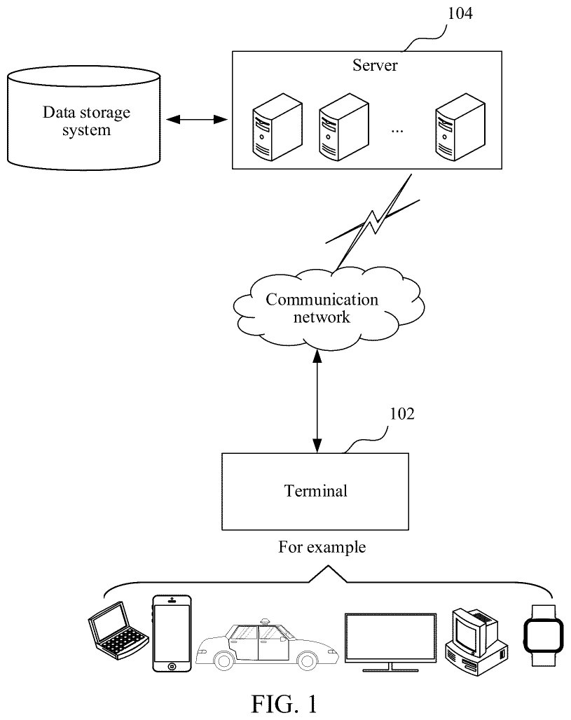

FIG. 1 is a diagram showing an application environment of a video detection method or a method for training a frosted glass region detection model in an embodiment. A terminal 102 communicates with a server 104 through a communication network. The terminal 102 may interact with the server 104 through the communication network. The terminal 102 may be, but not limited to, any one of various desktop computers, notebook computers, smartphones, tablet computers, Internet of Things devices, and portable wearable devices. The Internet of Things device may be a smart speaker, a smart TV, a smart air conditioner, a smart in-vehicle device, and the like. The portable wearable device may be a smart watch, a smart waistband, a head-mounted device, and the like. The server 104 may be implemented by using an independent server or a server cluster that includes a plurality of servers or a cloud server. The server 104 may store videos through a data storage system. The data storage system may be integrated into the server 104, or may be disposed separately from the server 104.

A video detection method provided in the present disclosure may be separately performed by a terminal or may be separately performed by a server. The method may be collaboratively performed by the terminal and the server. For example, the terminal sends a to-be-detected video to the server. After receiving the to-be-detected video, the server acquires a video frame sequence corresponding to the to-be-detected video, sequentially performs a frosted glass detection on each video frame in the video frame sequence by using a trained frosted glass region detection model, obtains a target video frame that includes a frosted glass region in the video frame sequence and a position of the frosted glass region in the target video frame, and clusters consecutive target video frames in the to-be-detected video according to an overlapping degree between positions of frosted glass regions, to obtain a plurality of consecutive target video clips; and outputs respective start and stop time of the plurality of consecutive target video clips in the to-be-detected video and the positions of the frosted glass regions.

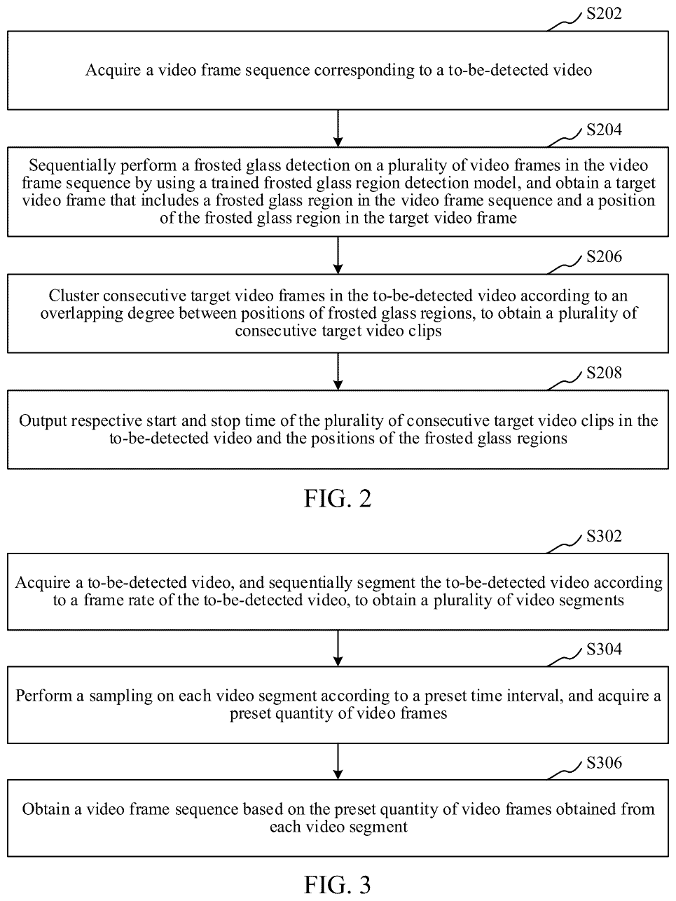

FIG. 2 is a schematic flowchart of a video detection method in an embodiment. An example in which the method is performed by a computer device (the terminal or the server in FIG. 1) is used for description. The method includes the following steps:

Step S202: Acquire a video frame sequence corresponding to a target video to be detected. The target video may also be referred to as to-be-detected video.

The to-be-detected video is a video on which a frosted glass detection is to be performed. In an embodiment, a video to be posted on a video platform may be used as the to-be-detected video. The to-be-detected video includes a plurality of video frames. The video frames correspond to different moments. The video frames are arranged according to a time order of the moments corresponding to the video frames, and the video frame sequence may be obtained. The video frame sequence may be formed according to all video frames included in the to-be-detected video, or may be formed according to some video frames in the to-be-detected video.

FIG. 3 is a schematic flowchart of acquiring a video frame sequence in an embodiment. With reference to FIG. 3, the computer device may perform the following steps: Step S302: Acquire a to-be-detected video, and sequentially segment the to-be-detected video according to a frame rate of the to-be-detected video, to obtain a plurality of video segments. Step S304: Perform a sampling on each video segment according to a preset time interval, and acquire a preset quantity of video frames. Step S306: Obtain a video frame sequence based on the preset quantity of video frames obtained from each video segment.

The video segment is a clip obtained by segmenting the to-be-detected video according to the frame rate of the to-be-detected video. For example, the frame rate of the to-be-detected video is F. A frame quantity of the to-be-detected video is A. A segmentation is performed once every F frames starting from the first video frame of the detection video, to obtain a corresponding video segment. According to the frame rate F, after the segmentation of the to-be-detected video including the A frames is completed, A/F video segments may be obtained. A calculation manner of the frame rate of the to-be-detected video may be a calculation performed by using a function cv2.CAP_PROP_FPS of open source components of OpenCV.

Next, a sampling is performed on a single video segment according to the preset time interval and the preset quantity to obtain the preset quantity of video frames. For example, a segmentation is performed according to the frame rate to obtain a video segment. A quantity of video frames included in the video segment is F. It is set that the preset quantity is N. In this case, the preset time interval may be represented by a frame quantity, and is F/N. A sampling is performed once every F/N frames. N video frames are obtained from the single video segment.

The sampling is performed on each video segment, so that N video frames in each video may be obtained. Based on the N video frames in each video and moments corresponding to the video frames, the video frames are arranged according to a time order, to obtain a video frame sequence. The video frames may be stored as Joint Photographic Experts Group (JPG) format images.

In the foregoing embodiment, the sampling is performed on the video segment according to the preset time interval. As the sampling is performed according to an average time distribution, the video frame sequence may comprehensively reflect the to-be-detected video. In addition, according to the frame rate of the to-be-detected video, the segmentation is performed on the to-be-detected video to form video segments, so that the comprehensive reflection of the video frame sequence can be further improved.

Step S204: Sequentially perform a frosted glass detection on each video frame in the video frame sequence by using a trained frosted glass region detection model, and obtain a target video frame that includes a frosted glass region in the video frame sequence and a position of the frosted glass region in the target video frame.

The frosted glass region detection model may be constructed based on a deep learning method, so that the frosted glass region detection model can learn knowledge for detecting a frosted glass region. The knowledge for detecting a frosted glass region includes various aspect ratios, various sizes, various opacity, and embedding of different types (for example, a text type and an icon type), so that the frosted glass region detection model has strong adaptability to variations in a frosted glass region. To enable the frosted glass region detection model to learn the knowledge for detecting a frosted glass region, frosted glass regions included in used training samples have a variety of different aspect ratios, sizes, opacity, and embedding types (for example, text types and icon types).

After the frosted glass region detection model performs a frosted glass detection on a video frame, outputted detection results include: whether a frosted glass region exists in a video frame, and for a video frame that includes a frosted glass region, a position of the frosted glass region. A video frame that includes a frosted glass region in the video frame sequence is referred to as a target video frame.

After obtaining the video frame sequence, the computer device sequentially inputs each video frame of the video frame sequence into the frosted glass region detection model, to enable the frosted glass region detection model to sequentially perform a frosted glass detection on the video frame, and output a detection result corresponding to the video frame, to determine a target video frame that includes a frosted glass region and a position of the frosted glass region in the target video frame.

Step S206: Cluster consecutive target video frames in the to-be-detected video according to an overlapping degree between positions of frosted glass regions, to obtain a plurality of consecutive target video clips.

Whether any two target video frames are consecutive target video frames may be determined according to whether a difference between display time corresponding to the two target video frames is less than or equal to a threshold. The threshold is, for example, 0.5 seconds.

In an embodiment, the computer device may acquire any two target video frames. When a difference between display time corresponding to the any two target video frames is less than or equal to the threshold, it is determined that the any two target video frames are consecutive target video frames.

Specifically, after determining each target video frame according to the frosted glass region detection model, the computer device saves the target video frame and corresponding display time. Next, the target video frames are arranged in a time order of display time, and it is determined whether two adjacent target video frames are consecutive target video frames. When determining whether two adjacent target video frames are consecutive target video frames, the computer device may acquire display time of the two adjacent target video frames, and when a difference between the display time of the two adjacent target video frames is less than or equal to the threshold, determine that the two adjacent target video frames are consecutive target video frames.

In the foregoing embodiment, according to the threshold and a difference between display time of two target video frames, consecutiveness of the target video frames is determined, thereby improving the convenience of consecutiveness determination.

The overlapping degree between positions of frosted glass regions is an overlapping degree between positions of frosted glass regions in two video frames. When the overlapping degree is higher, clustering performance of frosted glass regions in the two video frames is higher.

After obtaining consecutive target video frames, the computer device may cluster the target video frames according to overlapping degrees between positions of frosted glass region in the target video frames, to obtain a plurality of consecutive target video clips. Adjacent target video frames in a same target video clip are consecutive, and overlapping degrees of positions of frosted glass regions in the target video frames in the target video clip are high, and positions of frosted glass regions are close.

In an embodiment, the overlapping degree between positions of frosted glass regions may be measured by using a Jaccard distance. That is, the computer device may acquire a ratio of an intersection area to a union area of frosted glass regions of consecutive target video frames; and use the ratio as an overlapping degree of positions of frosted glass regions in the consecutive target video frames.

For example, two consecutive target video frames are respectively denoted as (1) and (2). The computer device may obtain, based on a position of a frosted glass region in the target video frame (1) and a position of a frosted glass region in the target video frame (2), an intersection area and a union area of the frosted glass regions in the target video frame (1) and the target video frame (2), and use a ratio of the intersection area to the union area as an overlapping degree between the positions of the frosted glass regions in the consecutive target video frames (1) and target video frame (2).

In the foregoing embodiment, a corresponding overlapping degree is obtained according to a ratio of an intersection area to a union area of frosted glass regions in target video frames, to represent clustering performance of the frosted glass regions in the target video frames more accurately.

Step S208: Output respective start and stop time of the plurality of consecutive target video clips in the to-be-detected video and the positions of the frosted glass regions.

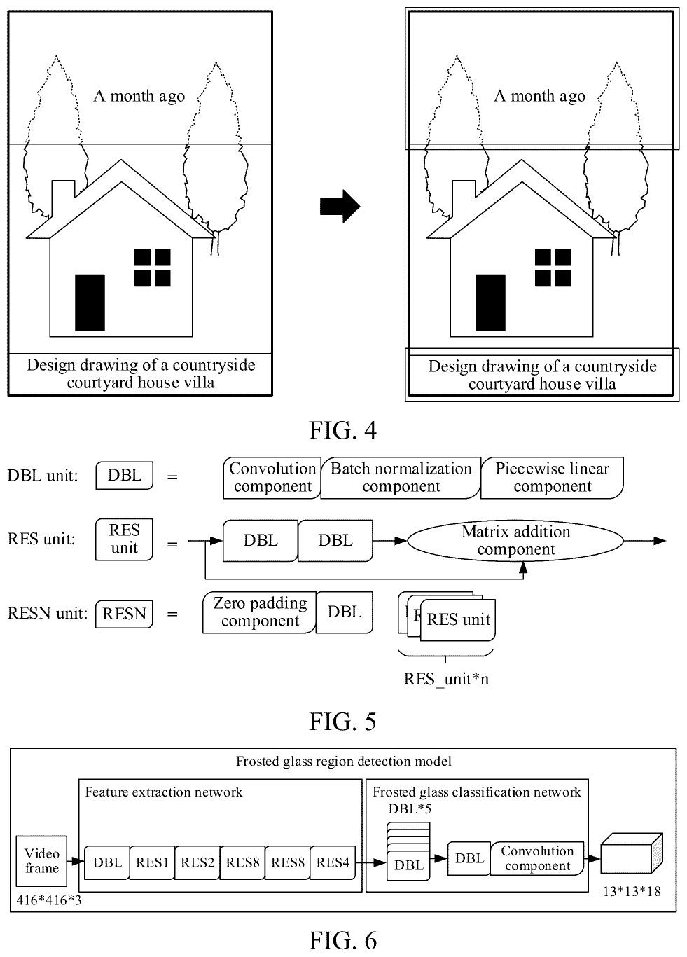

Because a frosted glass region in a single video does not remain unchanged, appearance time and an appearance region of the frosted glass region may vary in the video. Therefore, in the present disclosure, frosted glass regions are fused on a video level, to obtain a plurality of consecutive target video clips. Next, the consecutive target video clips are mapped to a time axis to obtain start and stop time of the consecutive target video clips in the to-be-detected video, and are outputted in a standard format. In addition, according to positions of frosted glass regions in target video frames in a single consecutive target video clip, positions of frosted glass regions in the single consecutive target video clip may be obtained. FIG. 4 is a schematic diagram of an effect of a frosted glass region detection in an embodiment. With reference to FIG. 4, after the processing of the foregoing steps S202 to S208, the positions of the frosted glass regions in the to-be-detected video may be acquired. The respective start and stop time of the consecutive target video clips in the to-be-detected video and the positions of the frosted glass regions are, for example:

```
  {
  [a time period 1, (an x coordinate value of an upper left corner, a y coordinate
value of the upper left corner, an x coordinate value of a lower right corner, y coordinate value of
the lower right corner)],
  [a time period 2, (an x coordinate value of an upper left corner, a y coordinate
value of the upper left corner, an x coordinate value of a lower right corner, y coordinate value of
the lower right corner)],
  ...
  };
```

A time period represents start and stop time of a single consecutive target video clip in the to-be-detected video. An x coordinate value of an upper left corner, a y coordinate value of the upper left corner, an x coordinate value of a lower right corner, and a y coordinate value of the lower right corner is a position of the frosted glass region in the single consecutive target video clip.

A corresponding instance may be:
{
[0s-10s, (0, 0, 200, 200)],
[12s-30s, (0, 0, 200, 400)],
...
},

In the foregoing video detection method, a frame-by-frame detection is performed on a video by using a trained frosted glass region detection model, so that a target video frame that includes a frosted glass region is provided, and a position of the frosted glass region in the target video frame is further provided, to implement high-precision detection of frosted glass. In addition, after a target video frame is obtained, the target video frame is segmented according to consecutiveness of video frames and an overlapping degree of positions of frosted glass regions, to form consecutive target video clips. Overlapping degrees between positions of frosted glass regions in a same video clip are greater than a threshold. In this way, start and stop time of an outputted target video clip in a to-be-detected video may reflect start and stop time of frosted glass regions in the to-be-detected video, and a position of a frosted glass region in the target video clip may reflect a position of frosted glass in the to-be-detected video, thereby improving the precision of a frosted glass detection. The method may be adequately applied to scenarios such as copyright management, copyright protection, video infringement management, infringement prevention, video security, and copyright security maintenance.

In an embodiment, when performing the frosted glass detection on the video frame by using the frosted glass region detection model, the computer device may sequentially input each video frame in the video frame sequence into the trained frosted glass region detection model; extract a feature map corresponding to the video frame by using a feature extraction network of the frosted glass region detection model; and obtain a class and a confidence level (confidence level may also be referred as confidence hereinafter) of each feature point in the feature map by using a frosted glass classification network of the frosted glass region detection model and based on the feature map of the video frame.

The frosted glass region detection model may include the feature extraction network and the frosted glass classification network. The feature extraction network may be DarkNet53, ResNet or Transformer obtained by performing pre-training based on an ImageNet data set. During actual application, if a frosted glass region accounts for a large area of a picture in a video, the frosted glass classification network may be a region detection channel network for a large target, to perform a detection on the frosted glass region, and a feature map outputted by the network may be a 13*13*18 three-dimensional matrix.

Underlying components used to construct the feature extraction network and the frosted glass classification network of the frosted glass region detection model may include: a convolutional component (CONV), a batch normalization component (BN), a piecewise linear component (Leaky Relu), a matrix addition component (Add), and a zero padding component (Zero padding). For detailed description of these underlying components, refer to Table 1.

TABLE 1

| Underlying component | Description |
|---|---|
| Convolutional | The convolutional component denotes a convolutional layer, and is |
| component (CONV) | essentially a functional mapping that maps a source multi-dimensional |
| | matrix into a target multi-dimensional matrix. The matrix obtained |
| | through mapping may be considered as an image feature. |
| Batch normalization | The batch normalization component is a batch normalization layer that |
| component (BN) | uses a calculation manner of normalization (normalization to: a mean |
| | value of 0 and a variance of 1) and then makes a delivery into a next |
| | layer of the model. |
| Piecewise linear | The piecewise linear component is a piecewise linear function that has |
| component (Leaky | a functional form of f(x) = x within an interval of x ≥ 0 and a |
| Relu) | functional form of f(x) = a * x within an interval of x < 0. The value of |
| | a is generally 0.01. LeakyReLU is proposed to solve a problem that |
| | neurons lack a gradient transfer within an interval of x < 0. |
| Matrix addition | The matrix addition component is a matrix addition operation. |
| component (Add) | |
| Zero padding | The zero padding component pads 0s to a feature matrix with a size |
| component (Zero | that does not meet a standard to increase the size of the feature matrix |
| padding) | to a standard form. |

Next, these underlying components may be used to construct upward a DBL unit, a Res unit, and a RESN unit. FIG. 5 is a schematic composition diagram of units in an embodiment. With reference to FIG. 5, a DBL unit is formed according to a convolutional component, a batch normalization component, and a piecewise linear component that are sequentially connected. A Res unit includes two DBL units and one matrix addition component. The first DBL unit, the second DBL unit, and the matrix addition component are sequentially connected. Input data inputted into the first DBL unit is also inputted into the matrix addition component. A RESN unit includes a zero padding component, a DBL unit, and n Res units. The zero padding component and the DBL unit are sequentially connected. An output result of the DBL unit is inputted into the n parallel Res units. When the quantity n of the Res units included in the RESN unit is 4, the RESN unit may be denoted as RES4. When the quantity n of the Res units included in the RESN unit is 2, the RESN unit may be denoted as RES1.

Based on the underlying components and units, the feature extraction network and the frosted glass classification network of the frosted glass region detection model may be formed. FIG. 6 is a schematic composition diagram of a frosted glass region detection model in an embodiment. With reference to FIG. 6, the feature extraction network includes a DBL unit and a plurality of RESN units. The RESN units are respectively RES1, RES2, RES8, RES8, and RES4. The DBL unit, RES1, RES2, RES8, RES8, and RES4 are sequentially connected. With reference to FIG. 6 again, the frosted glass classification network includes six DBL units and a convolutional component. Five DBL units are in parallel. Output results of the five parallel DBL units are inputted into the sixth DBL unit. The sixth DBL unit is connected in series to the convolutional component.

It is set that a video frame has a size of 416*416*3. After the video frame is processed by the frosted glass region detection model shown in FIG. 6, an outputted feature map may be a 13*13*18 three-dimensional matrix. The three-dimensional matrix includes 13*13 feature points. Predicted information corresponding to each feature point includes:
(1) a predicted position of each predicted candidate box;
(2) predicted confidence, representing a probability that a frosted glass region exists in the predicted candidate box; and
(3) a class, representing whether a target that exists in the predicted candidate box is a frosted glass region.

When the frosted glass classification network is a region detection channel network, each feature point may be used as a center point, referred to as an anchor, to achieve an a priori guidance. Next, predicted candidate boxes of three aspect ratios (a height is denoted as b_h, and a width is denoted as b_w) with the feature point as the center may be outputted, and the predicted candidate boxes can adequately frame a frosted glass region. A predicted position of a predicted candidate box may be represented by coordinates t_x and t_y of the center point and a height b_h and width b_w of the predicted candidate box.

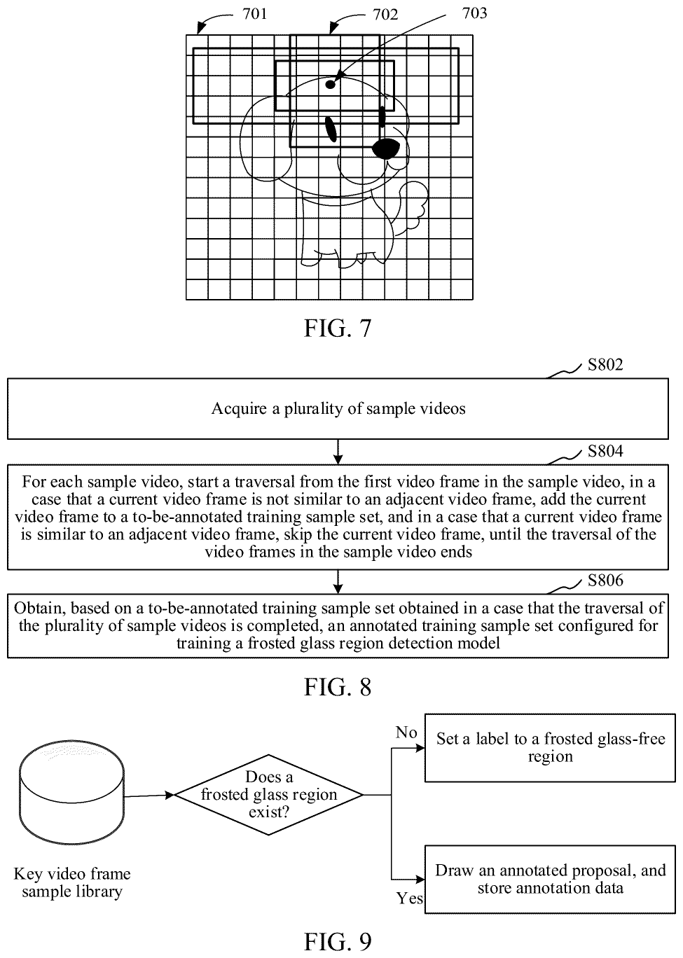

FIG. 7 is a schematic diagram of a role of an anchor structure in an embodiment. With reference to FIG. 7, a size formed by small boxes 701 is 13*13, denoting a 13*13 feature map. A center point 703 of each small box 701 corresponds to a feature point of the feature map. With the feature point as the center, predicted candidate boxes 702 of different aspect ratios are formed.

The predicted candidate boxes of three aspect ratios are hyperparameters. In deep learning, a hyperparameter is a parameter set before the deep learning is started, and is different from a parameter obtained through training. Generally, hyperparameters may be optimized to select a group of optimal hyperparameters, to improve the performance and effect of deep learning. The settings of an aspect ratio of a predicted candidate box are described below.

In an embodiment, after the class and the confidence level of each feature point in the feature map outputted by the frosted glass classification network of the frosted glass region detection model are obtained, the computer device may determine a frosted glass region detection result of the video frame based on confidence that a region corresponding to each feature point is a frosted glass region and a predicted position of a predicted candidate box corresponding to each feature point, where the frosted glass region detection result includes whether a frosted glass region exists in the video frame and a position of the frosted glass region; and obtain, according to the frosted glass region detection result of the video frame in the video frame sequence, the target video frame in which the frosted glass region exists in the video frame sequence and the position of the frosted glass region in the target video frame.

Each feature point of a single video frame has a corresponding class and corresponding confidence. Regions corresponding to which feature points are probably frosted glass regions. For a feature point that exists in the video frame, if a possibility that a region corresponding to the feature point is a frosted glass region is greater than a threshold, in this case, the video frame is a target video frame. For predicted positions of predicted candidate boxes of the feature point with the possibility greater than the threshold, the computer device may use the predicted position of each predicted candidate box as a position of the frosted glass region, to obtain a frosted glass detection result of the video frame, that is, that a frosted glass region exists in the video frame and a position of the frosted glass region.

In the foregoing embodiment, the frosted glass classification network is obtained through training using a large number of samples, and related knowledge for detecting a frosted glass region is learned. Therefore, a frosted glass region detection result of each video frame obtained by using a feature map outputted by the frosted glass classification network has high reliability, and the accuracy of the detection result is high.

A process of training the frosted glass region detection model is described below.

The training of the frosted glass region detection model may be a supervised training, an unsupervised training, or a semi-supervised training. The semi-supervised training is a combination of a supervised training and an unsupervised training. When the semi-supervised training is used, the frosted glass region detection model may be first trained by using an annotated training sample set to obtain an initial model, and then the initial model is trained by using an annotated training sample set and an unannotated training sample set to obtain a corresponding model. The model is used as the frosted glass region detection model for the frosted glass detection.

Content of the supervised training is described below:

In an embodiment, the computer device may acquire an annotated training sample set configured for training a frosted glass region detection model; determine, according to annotation data of each annotated training sample in the annotated training sample set, aspect ratios of frosted glass regions in the annotated training sample; cluster the aspect ratios of the frosted glass regions in the annotated training sample, to obtain a plurality of cluster centers; and after the aspect ratios represented by the cluster centers are used as hyperparameters for training the frosted glass region detection model, perform a supervised training on the frosted glass region detection model by using the annotated training sample.

Before the supervised training, an aspect ratio of a predicted candidate box used as a hyperparameter may be determined first. Specifically, when a frosted glass region exists in an annotated training sample, annotation data of the annotated training sample includes an aspect ratio of an annotated candidate box that frames the frosted glass region. In the annotated training sample set, the computer device may acquire aspect ratios corresponding to annotated training samples in which a frosted glass region exists, and cluster the aspect ratios. A clustering algorithm may be a K-means clustering algorithm. After the clustering is completed, the computer device may obtain a plurality of cluster centers, for example, three cluster centers, and next, use aspect ratios corresponding to the cluster centers as hyperparameters, so that during the supervised training, the frosted glass region detection model performs a prediction on the annotated training sample set based on the hyperparameters to obtain a corresponding prediction result.

In the foregoing embodiment, before the supervised training is performed, an aspect ratio of a predicted candidate box used as a hyperparameter is first determined based on the annotated training sample set used in the supervised training, thereby improving a learning capability of the frosted glass region detection model.

In an embodiment, the annotated training sample configured for training the frosted glass region detection model may be obtained in an annotation manner (for example, manual annotation). A process of acquiring an annotated training sample in an annotation manner is described below.

FIG. 8 is a schematic flowchart of obtaining an annotated training sample in an annotation manner in an embodiment. With reference to FIG. 8, the computer device may perform the following steps: Step S802: Acquire a plurality of sample videos. Step S804: For each sample video, start a traversal from the first video frame in the sample video, in a case that a current video frame is not similar to an adjacent video frame, add the current video frame to a to-be-annotated training sample set, and in a case that a current video frame is similar to an adjacent video frame, skip the current video frame, until the traversal of the video frames in the sample video ends. Step S806: Obtain, based on a to-be-annotated training sample set obtained in a case that the traversal of the plurality of sample videos is completed, an annotated training sample set configured for training a frosted glass region detection model.

The sample videos may be acquired from the internet. A scrapy library is used as an underlying Application Programming Interface (API) library to construct upward a video crawl script for a video platform. Videos are crawled from the video platform by using the video crawl script, and are used as the sample videos. A storage format of the sample video may be an mp4 format. During crawling, to obtain an effect of random crawling, videos on a page may be refreshed in manners such as a random page turning manner, a front page push refresh manner, and the like.

To improve annotation efficiency, a video frame with a similar picture may be eliminated, to avoid repeated annotation. Based on this, a near-view lens-based video frame deduplication method is used in the embodiments of the present disclosure. Specifically, a key video frame sample library S may be set first. Next, a deduplication traversal is performed on video frames in each sample video (a storage format of the video frames in the sample video may be an RGB format): The traversal is started from the first video frame in the sample video. When a current video frame is not similar to a video frame (for example, a video frame in the first 5 seconds) adjacent to the current video frame, the current video frame is added to the key video frame sample library S, and when a current video frame is similar to a video frame adjacent to the current video frame, the current video frame is skipped, and the current video frame is not added to the key video frame sample library S. Next, the deduplication traversal is performed on a next video frame, until the traversal of the video frames in the sample video is completed.

After the traversal of the video frames in each sample video is completed, the video frames included in the key video frame sample library S are used as the to-be-annotated training sample set, and annotation is performed to obtain the annotated training sample set.

To determine whether two video frames are similar, the computer device may acquire perceptual hash feature values of the two video frames, calculate a Hamming distance between the perceptual hash feature values of the two video frames, and determine whether the Hamming distance is less than a threshold (the threshold may be set to 3). If the Hamming distance between the perceptual hash feature values of the two video frames is less than the threshold, it is determined that the two video frames are similar. If the Hamming distance between the perceptual hash feature values of the two video frames is greater than the threshold, it is determined that the two video frames are not similar.

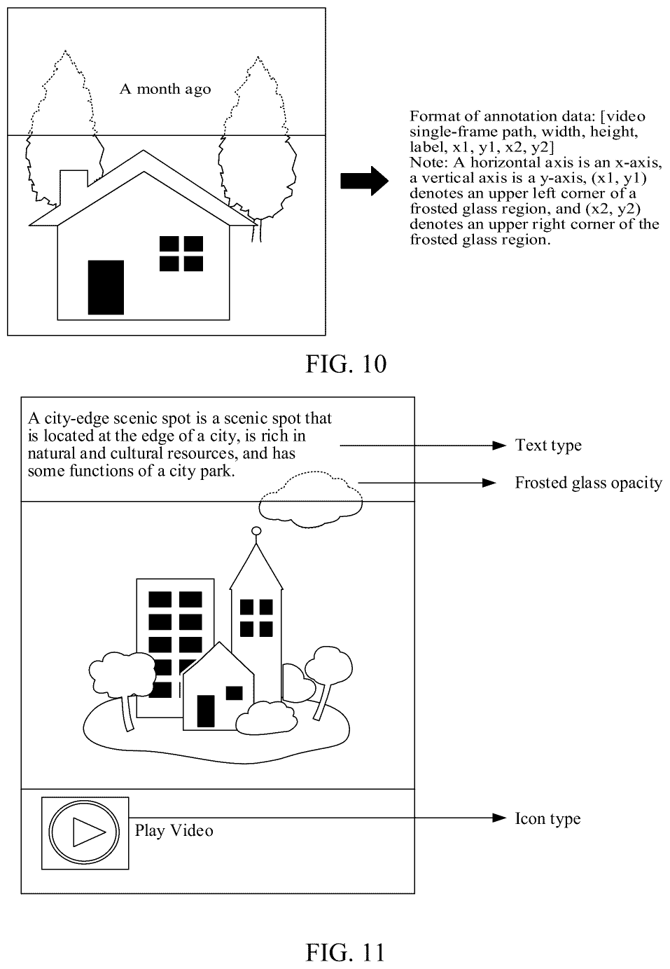

FIG. 9 is a schematic diagram of an annotation process in an embodiment. With reference to FIG. 9, the video frames included in the key video frame sample library S may be annotated based on an annotation application. In the annotation application, a folder in which the video frames included in the key video frame sample library S are located is inputted, and all the video frames included in the key video frame sample library S are traversed. FIG. 10 is a schematic diagram of annotation data in an embodiment. With reference to FIG. 10, when a frosted glass region exists in a video frame, a mouse is used to operate an annotated candidate box. The annotation application automatically stores annotation data of the video frame in a format [video frame path, width, height, labels x1, y1, x2, y2]. x1, y1, x2, and y2 respectively represent an x coordinate value of an upper left corner, a y coordinate value of the upper left corner, an x coordinate value of a lower right corner, and a y coordinate value of the lower right corner of the annotated candidate box. (x1, y1) denotes the upper left corner of the annotated candidate box, and (x2, y2) denotes the upper right corner of the annotated candidate box. For a video frame without a frosted glass region, an annotated candidate box may not be required, and it is only necessary to set a label of the video frame to a frosted glass-free region.

In the foregoing embodiment, the deduplication traversal is performed on the video frames in the sample video. When a current video frame is not similar to an adjacent video frame, the current video frame is annotated, to eliminate a video frame with a similar picture, thereby avoiding repeated annotation and improving the annotation efficiency.

In an embodiment, in sample videos crawled from the internet, most video frames have no frosted glass region. If a quantity of video frames with a frosted glass region is excessively small, it is difficult to train the frosted glass region detection model, and the generalization is poor. In this way, in the embodiments of the present disclosure, a simulation manner is used to supplement annotated training samples obtained in an annotation manner. A process of obtaining an annotated training sample in a simulation manner is described below.

In an embodiment, the computer device may acquire a frosted glass-free training sample annotated with a frosted glass-free region in an annotated training sample set; perform a frosted glass simulated embedding on the frosted glass-free training sample according to a set embedding position, to obtain a simulated frosted glass training sample; and after the embedding position is used as annotation data of the simulated frosted glass training sample, add a simulated frosted glass training sample annotated with a frosted glass region to the annotated training sample set.

The computer device may acquire frosted glass-free training samples annotated with a frosted glass-free region in the foregoing annotation manner, and simulate these frosted glass-free training samples. The computer device may perform a frosted glass simulated embedding on the frosted glass-free training sample according to a set embedding position, to obtain a simulated frosted glass training sample; and obtain x1, y1, x2, and y2 in annotation data of the simulated frosted glass training sample according to the embedding position, and add a simulated frosted glass training sample annotated with a frosted glass region to the annotated training sample set.

In the foregoing embodiment, the simulated frosted glass training sample is obtained in the simulation manner, so that annotation costs can be reduced. In addition, there are a great variety of simulation manners, and formed simulated frosted glass training samples cover frosted glass regions in various scenarios as much as possible, thereby improving the generalization performance of the frosted glass region detection model.

In an embodiment, a process of a frosted glass simulated embedding specifically includes the following step: The computer device may perform the frosted glass simulated embedding on the frosted glass-free training sample according to the set embedding position and based on at least one of frosted glass opacity, a text type of a frosted glass region, and an icon type of a frosted glass region, to obtain the simulated frosted glass training sample.

FIG. 11 is a schematic diagram of types used in a frosted glass simulated embedding in an embodiment. With reference to FIG. 11, the types used in the frosted glass simulated embedding may include at least one of frosted glass opacity, a text type, and an icon type.

The frosted glass opacity may be determined in a Gaussian blurring manner. For used parameters, refer to Table 2.

TABLE 2

| Parameter | Effect description of the parameter |
|---|---|
| Gaussian kernel size (ksize) | When the Gaussian kernel size is set larger, the |
| | blurring effect is stronger. |
| Standard deviation (sigmaX) of a Gaussian | When the standard deviation is set larger, the |
| kernel function in an X direction | blurring effect is stronger. |
| Standard deviation (sigmaY) of a Gaussian | When the standard deviation is set larger, the |
| kernel function in a Y direction | blurring effect is stronger. |

The computer device may obtain different parameter combinations based on the three parameters, and obtain different frosted glass opacity according to the parameter combinations in the Gaussian blurring manner. When frosted glass opacity is obtained according to a single parameter combination, values corresponding to parameters included in the parameter combination may be determined in a random manner, to simulate a variety of frosted glass regions.

Next, the computer device may randomly select an embedding position on the frosted glass-free training sample to perform frosted glass rendering. To make a simulation effect closer to an actual scenario, the embedding position may meet one of the following two points: (1) a length of one side is a width of the frosted glass-free training sample, and the side is close to an upper edge or a lower edge of the frosted glass-free training sample; and (2) a length of one side is a height of the frosted glass-free training sample, and the side is close to a left edge or a right edge of the frosted glass-free training sample.

After the embedding position is determined, the frosted glass-free training sample may be rendered according to the corresponding frosted glass opacity and the embedding position, to obtain x1, y1, x2, and y2 in the annotation data of the simulated frosted glass training sample.

For a text type, the text type is mainly related to a font, a text color, and text content.

For the font, various fonts may be set. During each frosted glass simulated embedding, one font may be randomly selected from the set various fonts. For the various fonts to be set, refer to Table 3.

TABLE 3

| | | | |
|---|---|---|---|
| SimSun | SimHei | KaiTi | STHupo |
| STLiti | STXinwei | STXingkai | STFangsong |
| Hannotate | PingFang | LingWai | Wawati |

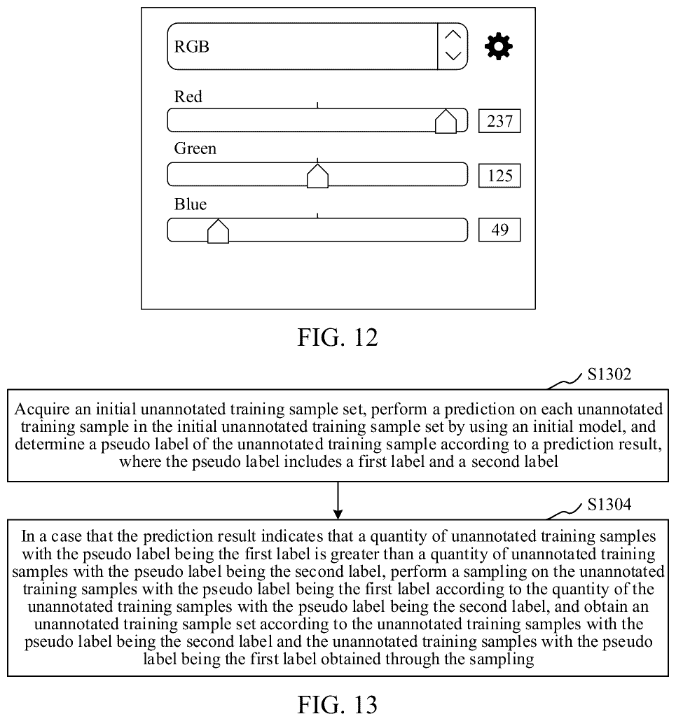

FIG. 12 is a schematic diagram of adjusting a text color in an embodiment. With reference to FIG. 12, for a text color, during each frosted glass simulated embedding, values may be randomly taken in a range of [0, 240] in three image color channels R, G, and B, to make a color distribution more varied, and 240 is a maximum value, which may keep the color of a text from becoming excessively light.

For text content, a news text may be crawled from the internet. After the news text is divided into sentences, each sentence is used as an independent unit to construct a text library. During each frosted glass simulated embedding, one sentence is randomly chosen from the text library and used as text content of the current frosted glass simulated embedding.

For each frosted glass-free training sample, an embedding of a text type may be performed 0 times to 5 times. During each embedding, text rendering may be performed according to the foregoing description, and an embedding is performed at a random embedding position. In this way, a text embedding is completed, to obtain a corresponding simulated frosted glass training sample.

For the icon type, the icon type is mainly related to icon content and an appearance change of an icon.

For icon content, the computer device may crawl a large number of icons with small sizes and images from the internet, and use the sizes and images to construct an icon library, and then an icon is selected from the icon library in a random manner.

For the appearance change of the icon, the computer device may use change manners such as rotation, mirroring, transparency change, sharpness change, and chromatic aberration change. During each frosted glass simulated embedding, 0 to 2 change manners are randomly selected, a selected icon is changed, and then is embedded into the frosted glass-free training sample.

For each frosted glass-free training sample, an embedding of an icon type is performed 0 times to 3 times. During each embedding, processing is performed according to the foregoing description, and an embedding is performed at a random embedding position. In this way, an embedding of an icon type is completed.

In the foregoing embodiment, the frosted glass simulated embedding is performed on the frosted glass-free training sample based on at least one of frosted glass opacity, a text type of a frosted glass region, and an icon type of a frosted glass region, to obtain the simulated frosted glass training sample, so that the frosted glass region detection model can learn related knowledge for detecting a frosted glass region in various scenarios, thereby improving the generalization performance of the frosted glass region detection model.

In an embodiment, the steps of the supervised training of the frosted glass region detection model include: performing a prediction on an annotated training sample in an annotated training sample set by using the frosted glass region detection model, to obtain predicted information of each feature point in a feature map of the annotated training sample, where the predicted information of the feature point includes: a predicted position of a predicted candidate box, predicted confidence of whether frosted glass exists in the predicted candidate box, and predicted confidence of whether the predicted candidate box is frosted glass; obtaining a first class loss, a second class loss, and a third class loss of the annotated training sample based on the predicted information of the feature point in the feature map and annotation data of the annotated training sample, where the first class loss represents a loss between a position of a predicted candidate box and a position of an annotated candidate box, the second class loss represents a loss between predicted confidence that frosted glass exists in a region corresponding to the feature point and annotated confidence and represents a loss between predicted confidence that frosted glass does not exist in a region corresponding to the feature point and actual confidence, and the third class loss represents a loss between predicted confidence of whether frosted glass exists in a region corresponding to the feature point and actual confidence; and adjusting model parameters of the frosted glass region detection model based on the first class loss, the second class loss, and the third class loss of the annotated training sample in the annotated training sample set, to perform the supervised training on the frosted glass region detection model.

The computer device may obtain the annotated training sample set in the foregoing annotation manner and simulation manner. Next, the annotated training sample set is inputted into the frosted glass region detection model to perform the supervised training, and a loss function used in the supervised training is:

$${Loss}_{N} = {λ}_{box} {\sum }_{i = 0}^{N 1 \times N 1} {\sum }_{j = 0}^{3} {l}_{ij}^{obj} [ {( {t}_{x} - {{t}^{′}}_{x} )}^{2} + {( {t}_{y} - {{t}^{′}}_{y} )}^{2} ] + {λ}_{box} {\sum }_{i = 0}^{N 1 \times N 1} {\sum }_{j = 0}^{3} {l}_{ij}^{obj} [ {( {t}_{w} - {{t}^{′}}_{w} )}^{2} + {( {t}_{h} - {{t}^{′}}_{h} )}^{2} ] - {λ}_{box} {\sum }_{i = 0}^{N 1 \times N 1} {\sum }_{j = 0}^{3} {l}_{ij}^{obj} log ( {c}_{ij} ) - {λ}_{noobj} {\sum }_{i = 0}^{N 1 \times N 1} {\sum }_{j = 0}^{3} {l}_{ij}^{noobj} log ( 1 - {c}_{ij} ) - {λ}_{class} {\sum }_{i = 0}^{N 1 \times N 1} {\sum }_{j = 0}^{3} {\sum }_{c ∈ classes} [ {{p}^{′}}_{ij} ( c ) log ( {p}_{ij} ( c ) ) + ( 1 - {{p}^{′}}_{ij} ( c ) ) log ( 1 - {p}_{ij} ( c ) ) ] .$$

A loss of each of the first two items of the loss function is the first class loss. The first class loss represents a loss between a position of a predicted candidate box and a position of an annotated candidate box. λ_{box} is a proposal loss weight, N1 is a length and a width (the length and the width are the same, and it may be set that N1 =13) of a feature map, tₓ and t_{y} are intermediate points of the annotated candidate box, t′ₓ and t′_{y} are intermediate points of the predicted candidate box, tₕ and t_{w} are a height and a width of the annotated candidate box, and t′ₕ and t′_{w} are a height and a width of a predicted candidate box box.

A loss of each of the third item and the fourth item of the loss function is the second class losses. The second class loss represents a loss between predicted confidence that frosted glass exists in a region corresponding to the feature point and annotated confidence and represents a loss between predicted confidence that frosted glass does not exist in a region corresponding to the feature point and actual confidence. λ_{obj} is a confidence weight of the predicted candidate box, lᵢⱼ^{obj} is predicted confidence that frosted glass exists in a j^{th} predicted candidate box of an i^{th} feature point, and cᵢⱼ is annotated confidence that a frosted glass target exists in the j^{th} predicted candidate box of the i^{th} feature point. λ_{noobj} is a confidence weight that frosted glass does not exist in the predicted candidate box, and lᵢⱼ^{noobj} is predicted confidence that frosted glass does not exist in the j^{th} predicted candidate box of the i^{th} feature point.

A loss of the fifth item of the loss function is the third class loss. The third class loss represents a loss between predicted confidence of whether frosted glass exists in a region corresponding to the feature point and actual confidence. λ_{class} is a class weight, p′ᵢⱼ(c) is predicted confidence of a c^{th} class by the j^{th} predicted candidate box of the i^{th} feature point, and pᵢⱼ(c) is annotated confidence of the c^{th} class by the j^{th} predicted candidate box of the i^{th} feature point. In the embodiments of the present disclosure, there is only one class of frosted glass, and no frosted glass is a background, and is not considered as a class. Therefore, c may be set to 1.

According to the items of the loss function, after losses of different classes are obtained, a labeled training loss of the annotated training sample set is obtained according to addition and subtraction relationships between the items of the loss function, and the model parameters of the frosted glass region detection model are adjusted by using the labeled training loss, to perform the supervised training on the frosted glass region detection model. During the supervised training, a function of SGD with momentum may be used for a trained optimizer. An initial learning rate is 0.001, and a learning rate descent strategy of gradient descent is used. The learning rate is reduced to 0.96 times of the original learning rate in every five epochs. When the labeled training loss no longer descends, the supervised training ends.

In the foregoing embodiment, during the supervised training, losses of a plurality of classes are combined to adjust model parameters, thereby improving the detection performance of the frosted glass region detection model.

During the supervised training, the annotated training sample is obtained in an annotation manner, and costs are large. As a result, a quantity of annotated training samples is naturally small. The simulated frosted glass training sample is constructed by using the frosted glass-free training sample, and annotated frosted glass samples obtained in an annotation manner may be supplemented. However, a quantity of samples that can be supplemented is also limited by the quantity of the frosted glass-free training samples. The quantity of annotated training samples obtained in the annotation manner and the simulation manner is limited, and it is difficult to make the frosted glass region detection model reach good detection performance.

Based on the internet video downloading method described above, a quantity of videos that can be obtained is not limited. Embodiments of the present disclosure provide a manner of performing a semi-supervised training on a frosted glass region detection model. A manner of the semi-supervised training is mainly training the frosted glass region detection model by using the unannotated training sample set and the annotated training sample set, to improve the detection performance of the frosted glass region detection model, thereby improving the generalization of the model.

In an embodiment, the computer device may acquire an unannotated training sample set, perform a data augmentation on an unannotated training sample in the unannotated training sample set, and obtain an unannotated sample similarity pair based on the unannotated training sample and the augmented training sample; use a frosted glass region detection model obtained by performing a supervised training by using an annotated training sample set as an initial model, perform a prediction on the training samples included in the unannotated sample similarity pair respectively by using the initial model, and acquire respective prediction results of the training samples included in the unannotated sample similarity pair; obtain a consistency loss of the unannotated sample similarity pair based on a difference between the respective prediction results of the training samples included in the unannotated sample similarity pair; and obtain a joint loss based on the consistency loss of the unannotated sample similarity pair and a labeled training loss of an annotated training sample, and adjust model parameters of the initial model by using the joint loss, to obtain the trained frosted glass region detection model.

The unannotated sample similarity pair includes an unannotated training sample (which may be denoted as U) and an augmented training sample (which may be denoted as U′) obtained by augmenting the unannotated training sample. An augmentation manner may be: adjusting saturation, contrast, and tone of the unannotated training sample, and adding Gaussian noise.

In an embodiment, the unannotated training sample set may be obtained through class balancing. FIG. 13 is a schematic flowchart of class balancing in an embodiment. With reference to FIG. 13, the class balancing mainly includes: Step S1302: Acquire an initial unannotated training sample set, perform a prediction on each unannotated training sample in the initial unannotated training sample set by using an initial model, and determine a pseudo label of the unannotated training sample according to a prediction result, where the pseudo label includes a first label and a second label. Step S1304: In a case that the prediction result indicates that a quantity of unannotated training samples with the pseudo label being the first label is greater than a quantity of unannotated training samples with the pseudo label being the second label, perform a sampling on the unannotated training samples with the pseudo label being the first label according to the quantity of the unannotated training samples with the pseudo label being the second label, and obtain an unannotated training sample set according to the unannotated training samples with the pseudo label being the second label and the unannotated training samples with the pseudo label being the first label obtained through the sampling.

After the initial unannotated training sample set is predicted by using the initial model, the pseudo labels of the unannotated training samples in the initial unannotated training sample set are obtained. If the quantity of the unannotated training samples with the first label is greater than the quantity of the unannotated training samples with the second label, a sampling is performed on the unannotated training samples with the pseudo label being the first label according to the quantity of the unannotated training samples with the pseudo label being the second label, to make the quantity of the unannotated training samples with the first label obtained through the sampling consistent with the quantity of the unannotated training samples with the second label. Next, the unannotated training sample set is obtained according to the unannotated training samples with the first label obtained through the sampling and the unannotated training samples with the second label, and the unannotated training sample set is obtained by performing the class balancing.

In the foregoing embodiment, a pseudo label is obtained based on a prediction result of the initial model, and the class balancing is performed, to avoid overfitting of prediction of a large number of classes by the frosted glass region detection model, thereby improving the detection performance of the frosted glass region detection model.

After obtaining the unannotated training sample set after the class balancing, the computer device augments the unannotated training sample in the augmentation manner described above, the unannotated sample similarity pair is formed. Next, the training samples included in the unannotated sample similarity pair are respectively predicted by using the initial model. The prediction may be a consistency prediction.

The consistency prediction is one of the main methods for extracting a signal from the unlabeled training sample in the semi-supervised training. The consistency prediction is combined into the semi-supervised training, to require that after disturbance occurs in data, the frosted glass region detection model can still accurately predict the data. The consistency prediction specifically refers to that for massive readily available unannotated training samples U and training samples U′ obtained by augmenting U (the augmentation manner herein is described above), a set target function forces the frosted glass region detection model to perform the consistency prediction on the unannotated training samples U and the training samples U′ obtained by augmenting U. That is, prediction results of the two by the frosted glass region detection model are supposed to be consistent. The consistency prediction is equivalent to specifying an objective for the generalization capability of the frosted glass region detection model, and a large number of unlabeled training samples are used to guide the frosted glass region detection model to progress toward the objective of high generalization.

The set target function may be set by using an MSE, which is:

$${U}_{θ} ( {u}^{′} , u ) = {\sum }_{i}^{n} {( {p}_{θ} ( {u}_{i} ) - {p}_{θ} ( {{u}^{′}}_{i} ) )}^{2} .$$

p_{θ}(uᵢ) is a prediction result of an unannotated training sample U, p_{θ}(u′ᵢ) is a prediction result of an augmented training sample U′, and an output of a function p_{θ} is a 13*13*18 three-dimensional matrix. The subtraction in the foregoing formula denotes a point-to-point subtraction of two 13*13*18 matrices, and the square denotes a square sum of all matrix points after subtraction. i denotes an i^{th} training sample in a current batch, n denotes a quantity of training samples in the current batch, and an objective of a training process is to reduce a loss function.

In addition, in the target function, based on settings by using an MSE, loss functions such as KL divergence may further be added for supplementation.

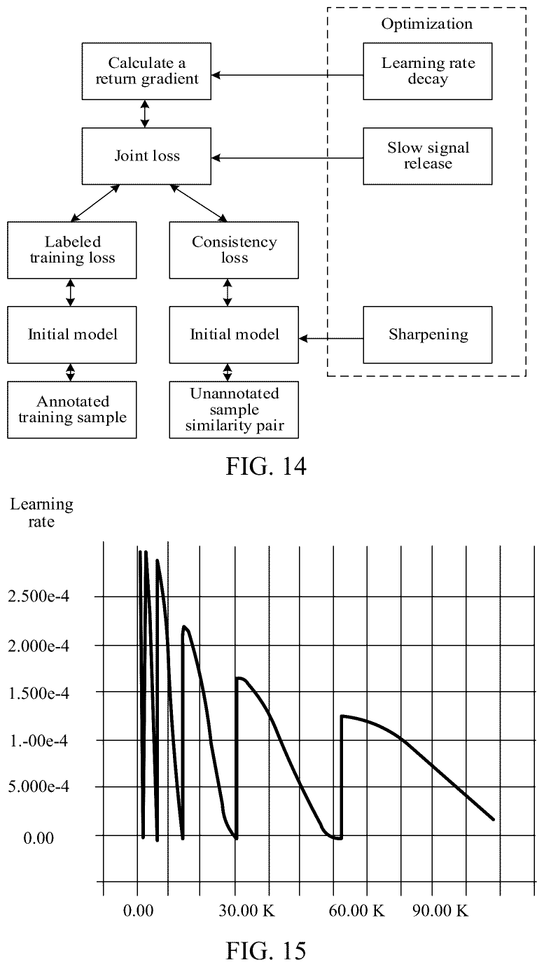

FIG. 14 is a schematic diagram of a semi-supervised training framework in an embodiment. With reference to FIG. 14, the computer device obtains a consistency loss of the unannotated sample similarity pair based on a difference between the respective prediction results of the training samples included in the unannotated sample similarity pair outputted by the initial model, and next, obtains a joint loss in combination with the labeled training loss of the annotated training sample, calculates a return gradient based on the joint loss, and adjusts model parameters of the initial model according to the joint loss to perform the semi-supervised training, to obtain the trained frosted glass region detection model.

A formula of the joint loss may be: L_{θ}(y)=Loss_{N}+λU_{θ}. L_{θ}(y) is the joint loss, Loss_{N} is the labeled training loss, U_{θ} is the consistency loss, and λ is a parameter for adjusting a ratio of the labeled training loss to the consistency loss.

In the foregoing embodiment, the consistency loss is obtained by using the unannotated training sample set, the labeled training loss is obtained by using the annotated training sample set, and the model parameters of the frosted glass region detection model are adjusted according to a joint consistency loss and the labeled training loss to perform the semi-supervised training, thereby improving the detection performance of the frosted glass region detection model, and improving the generalization of the model performance.

In an embodiment, during the semi-supervised training, because a quantity of annotated training samples is small, overfitting may occur. To avoid rapid overfitting during the semi-supervised training, with reference to FIG. 14, the embodiments of the present disclosure propose a slow signal release strategy.

In an embodiment, in a process of obtaining the joint loss based on the consistency loss of the unannotated sample similarity pair and a labeled training loss of the annotated training sample, the computer device may acquire, according to a prediction result of the annotated training sample by the initial model, predicted confidence of whether a frosted glass region exists in the annotated training sample; use an annotated training sample with the predicted confidence of whether a frosted glass region exists being less than or equal to a threshold as a target training sample; and obtain the joint loss based on the consistency loss of the unannotated sample similarity pair and a labeled training loss of the target training sample.

In the foregoing manner, for the annotated training sample, when predicted confidence is excessively high, it represents that the frosted glass region detection model is overconfident of the prediction of the part of samples. The part of samples tends to cause overfitting of the part of samples in the training process of the frosted glass region detection model. Based on this, in the embodiments of the present disclosure, annotated training samples with the predicted confidence being less than or equal to the threshold are used as target training samples to participate in loss calculation, and annotated training samples with the predicted confidence greater than the threshold are eliminated to keep the annotated training samples from participating in loss calculation. Errors of the annotated training samples arranged kept from being transferred backward, thereby preventing the overfitting of the part of samples in the training process of the frosted glass region detection model.

Specifically, at a moment t in the training process, the threshold is set to ηt, and 1/K≤ηt≤1. K is a quantity of classes. In the embodiments of the present disclosure, K=2. When predicted confidence of an annotated training sample in class is greater than the threshold ηt, the annotated training sample is eliminated to keep the annotated training sample from participating in loss calculation.

In the foregoing embodiments, annotated training samples with the predicted confidence being less than or equal to the threshold are used as target training samples to participate in loss calculation, and annotated training samples with the predicted confidence greater than the threshold are eliminated to keep the annotated training samples from participating in loss calculation. Errors of the annotated training samples arranged kept from being transferred backward, thereby preventing the overfitting of the part of samples in the training process of the frosted glass region detection model.

In an embodiment, the computer device may sharpen the respective prediction results of the training samples included in the unannotated sample similarity pair, and calculate the consistency loss of the unannotated sample similarity pair according to the sharpened prediction results.

When a quantity of annotated training samples is small, the initial model does not have enough knowledge of annotated training samples. A distribution of predicted values included in prediction results of the unannotated training sample may be very flat. In this case, the joint loss mainly comes from the annotated training sample. This does not conform to the idea of performing a semi-supervised training by using unlabeled training samples. A rich distribution of predicted values included in prediction results of unannotated training samples is conducive to the semi-supervised training.

Based on this, in the embodiments of the present disclosure, the respective prediction results of the training samples included in the unannotated sample similarity pair are sharpened, and the consistency loss of the unannotated sample similarity pair is calculated according to the sharpened prediction results, to obtain a corresponding joint loss.

In the foregoing embodiments, respective prediction results of the training samples included in the unannotated sample similarity pair are sharpened, to avoid a case that a joint loss mainly comes from the labeled training loss, which is conducive to the semi-supervised training.

In an embodiment, a sharpening manner includes: in a case that predicted confidence in the prediction results of the training samples included in the unannotated sample similarity pair is greater than a threshold, keeping the unannotated sample similarity pair to participate in the calculation of the consistency loss; and when the predicted confidence in the prediction results of the training samples included in the unannotated sample similarity pair is less than the threshold, eliminating the unannotated sample similarity pair to keep the unannotated sample similarity pair from participating in the calculation of the consistency loss.

When predicted confidence of an unannotated training samples is low, it represents that a prediction effect of the unannotated training sample by the initial model is not good. In this case, an unannotated sample similarity pair to which the unannotated training sample belongs does not participate in the calculation of the consistency loss. When predicted confidence of an unannotated training samples is high, it represents that a prediction effect of the unannotated training sample by the initial model is good. In this case, an unannotated sample similarity pair to which the unannotated training sample belongs may participate in the calculation of the consistency loss.

In the foregoing embodiment, unannotated training samples with low predicted confidence are eliminated and are kept from participating in the calculation of the consistency loss. This is confidence-based masking manner of sharpening, to implement sharpening of the unannotated training sample, which is conducive to the semi-supervised training.

In an embodiment, the sharpening manner further includes: a min-entropy manner and a Softmax control manner. In the min-entropy manner, a value of an entropy is added during calculation of a consistency loss, so that a prediction by the frosted glass region detection model may approximate to an unannotated sample similarity pair with a small entropy. In the Softmax control manner, an output value is controlled by adjusting a Softmax function. Confidence in class may be calculated by using Softmax(1(X)/τ). 1(X) represents the confidence in class, and τ represents temperature. When τ is small, a distribution sharper. During sharpening, the confidence-based masking manner and the min-entropy manner may be used.

In an embodiment, with reference to FIG. 14, the computer device may use a cosine decay restarts learning rate (CDRLR) learning rate decay strategy, and a small quantity of annotated training samples may make the frosted glass region detection model reach a local extremum point sooner. FIG. 15 is a schematic diagram of learning rate decay in an embodiment. With reference to FIG. 15, a Cosine cycle decay learning rate has a cyclic characteristic. Regular changes in the learning rate are helpful for a model to jump out of a local extremum point and look for a better extremum point.

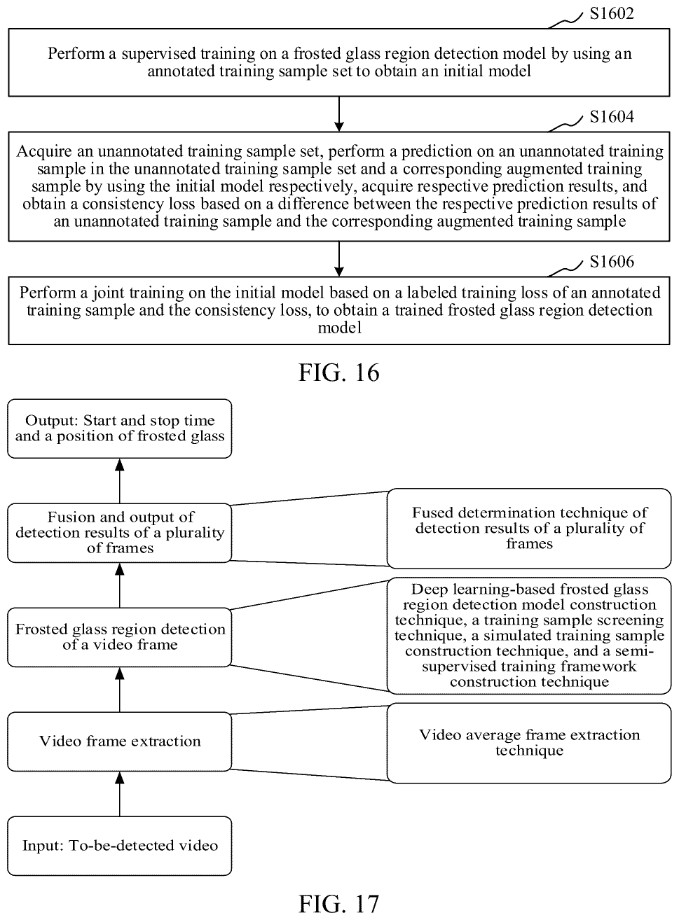

In an embodiment, the present disclosure provides a method for training a frosted glass region detection model. FIG. 16 is a schematic flowchart of a method for training a frosted glass region detection model in an embodiment. An example in which the method is performed by a computer device (the terminal or the server in FIG. 1) is used for description. The method includes the following steps:

Step S1602: Perform a supervised training on a frosted glass region detection model by using an annotated training sample set to obtain an initial model.

The annotated training sample may be obtained in an annotation manner and a simulation manner.

A process of acquiring an annotated training sample in the annotation manner includes the following steps: The computer device acquires a plurality of sample videos; for each sample video, starts a traversal from the first video frame in the sample video, in a case that a current video frame is not similar to an adjacent video frame, add the current video frame to a to-be-annotated training sample set, and in a case that a current video frame is similar to an adjacent video frame, skip the current video frame, until the traversal of the video frames in the sample video ends; Obtain, based on a to-be-annotated training sample set obtained in a case that the traversal of the plurality of sample videos is completed, an annotated training sample set configured for training a frosted glass region detection model.

A process of acquiring an annotated training sample in the simulation manner includes the following steps: The computer device acquires a frosted glass-free training sample annotated with a frosted glass-free region in an annotated training sample set; performs a frosted glass simulated embedding on the frosted glass-free training sample according to a set embedding position, to obtain a simulated frosted glass training sample; and after the embedding position is used as annotation data of the simulated frosted glass training sample, adds a simulated frosted glass training sample annotated with a frosted glass region to the annotated training sample set.

Step S1604: Acquire an unannotated training sample set, perform a prediction on an unannotated training sample in the unannotated training sample set and a corresponding augmented training sample by using the initial model respectively, acquire respective prediction results, and obtain a consistency loss based on a difference between the respective prediction results of an unannotated training sample and the corresponding augmented training sample.

For an unannotated training sample (which may be denoted as U) and an augmented training sample (which may be denoted as U′) obtained by augmenting the unannotated training sample. An augmentation manner may be: adjusting saturation, contrast, and tone of the unannotated training sample, and adding Gaussian noise.

After obtaining a prediction result of the unannotated training sample U and a prediction result of the augmented training sample U′, the computer device obtains a consistency loss according to

$${U}_{θ} ( {u}^{′} , u ) = {\sum }_{i}^{n} {( {p}_{θ} ( {u}_{i} ) - {p}_{θ} ( {{u}^{′}}_{i} ) )}^{2} .$$

p_{θ}(uᵢ) is a prediction result of an unannotated training sample U, p_{θ}(u′ᵢ) is a prediction result of an augmented training sample U′, and an output of a function p_{θ} is a 13*13*18 three-dimensional matrix. The subtraction in the foregoing formula denotes a point-to-point subtraction of two 13*13*18 matrices, and the square denotes a square sum of all matrix points after subtraction. i denotes an i^{th} training sample in a current batch, n denotes a quantity of training samples in the current batch, and an objective of a training process is to reduce a loss function.

Step S1606: Perform a joint training on the initial model based on a labeled training loss of an annotated training sample and the consistency loss, to obtain a trained frosted glass region detection model.

A formula of the joint loss may be: L_{θ}(y)=Loss_{N}+λU_{θ}. L_{θ}(y) is the joint loss, Loss_{N} is the labeled training loss, U_{θ} is the consistency loss, and λ is a parameter for adjusting a ratio of the labeled training loss to the consistency loss.

In the foregoing embodiment, a supervised training is first performed on a frosted glass region detection model, an unannotated training sample set is predicted based on an initial model obtained through the supervised training, to obtain a consistency loss between an unannotated training sample and a corresponding augmented training sample, and the initial model is jointly trained based on a labeled training loss of an annotated training sample and the consistency loss, so that while annotation costs can be reduced, the detection performance of the frosted glass region detection model is enhanced. The method may be adequately applied to scenarios such as copyright management, copyright protection, video infringement management, infringement prevention, video security, and copyright security maintenance.

To better understand the foregoing method, one embodiment of the present disclosure is described below in detail. FIG. 17 is a schematic diagram of a video detection framework in an embodiment. With reference to FIG. 17, this embodiment mainly includes three parts: video frame extraction, frosted glass region detection of a video frame, and fusion and output of detection results of a plurality of frames. Implementation techniques mainly include a video average frame extraction technique, a deep learning-based frosted glass region detection model construction technique, a training sample screening technique, a simulated training sample construction technique, and a semi-supervised training framework construction technique, a fused determination technique of detection results of a plurality of frames, and the like.

This embodiment mainly includes the following steps:
acquiring the to-be-detected video, and sequentially segmenting the to-be-detected video according to a frame rate of the to-be-detected video, to obtain a plurality of video segments;
performing a sampling on each video segment according to a preset time interval, and acquiring a preset quantity of video frames;
obtaining a video frame sequence based on the preset quantity of video frames obtained from each video segment;
sequentially inputting each video frame in the video frame sequence into the trained frosted glass region detection model;
extracting a feature map corresponding to the video frame by using a feature extraction network of the frosted glass region detection model;
obtaining a class and a confidence of each feature point in the feature map by using a frosted glass classification network of the frosted glass region detection model and based on the feature map of the video frame;
acquiring the class and the confidence of each feature point in the feature map outputted by the frosted glass classification network;
determining a frosted glass region detection result of the video frame based on confidence that a region corresponding to each feature point in the feature map is a frosted glass region and a predicted position of a predicted candidate box corresponding to each feature point, where the frosted glass region detection result includes whether a frosted glass region exists in the video frame and a position of the frosted glass region; and
obtaining, according to the frosted glass region detection result of the video frame in the video frame sequence, the target video frame in which the frosted glass region exists in the video frame sequence and the position of the frosted glass region in the target video frame;
acquiring any two target video frames; and
in a case that a difference between display time corresponding to the any two target video frames is less than or equal to a threshold, determining that the any two target video frames are consecutive target video frames;
acquiring a ratio of an intersection area to a union area of the frosted glass regions of the consecutive target video frames;
using the ratio as the overlapping degree between the positions of the frosted glass regions in the consecutive target video frames;
clustering consecutive target video frames in the to-be-detected video according to an overlapping degree between positions of frosted glass regions, to obtain a plurality of consecutive target video clips; and
outputting respective start and stop time of the plurality of consecutive target video clips in the to-be-detected video and the positions of the frosted glass regions.

In this embodiment, a process of training the frosted glass region detection model mainly includes the following steps:
acquiring an annotated training sample set configured for training a frosted glass region detection model;
determining, according to annotation data of each annotated training sample in the annotated training sample set, aspect ratios of frosted glass regions in the annotated training sample;
clustering the aspect ratios of the frosted glass regions in the annotated training sample, to obtain a plurality of cluster centers; and
after the aspect ratios represented by the cluster centers are used as hyperparameters for training the frosted glass region detection model, performing a supervised training on the frosted glass region detection model by using the annotated training sample.

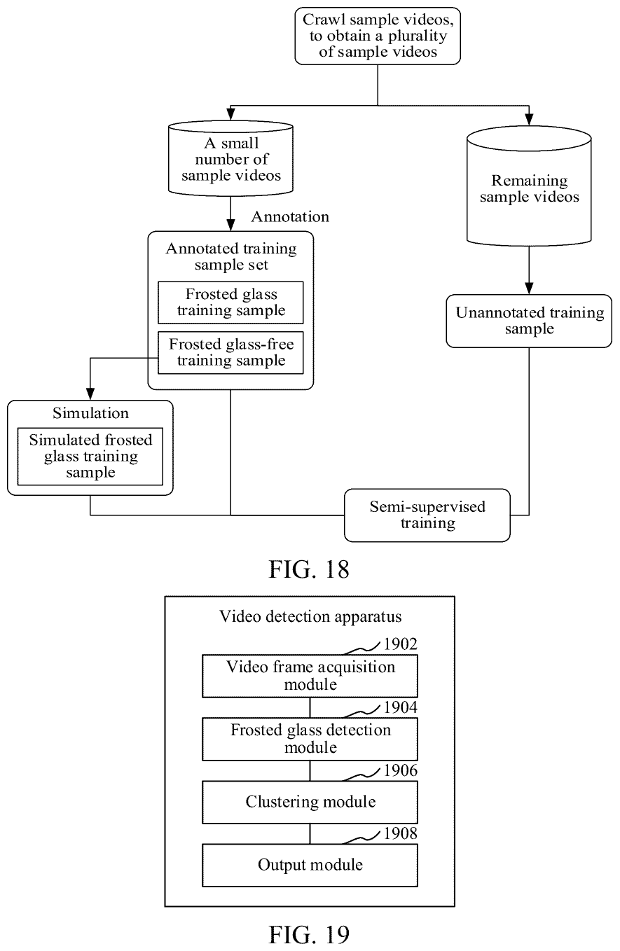

FIG. 18 is a schematic diagram of a training sample source used in semi-supervised training in an embodiment. With reference to FIG. 18, the annotated training sample set may be obtained in an annotation manner and a simulation manner. A case of obtaining the annotated training sample set in the annotation manner mainly includes the following steps:
crawling sample videos, to obtain a plurality of sample videos;
taking a small number of sample videos from the plurality of sample videos, and obtaining the remaining sample videos, where the small number of sample videos are configured for forming the annotated training samples, and the remaining sample videos are configured for forming the unannotated training samples;
for each sample video, starting a traversal from the first video frame in the sample video, in a case that a current video frame is not similar to an adjacent video frame, adding the current video frame to a to-be-annotated training sample set, and in a case that a current video frame is similar to an adjacent video frame, skipping the current video frame, until the traversal of the video frames in the sample video ends;
obtaining, based on a to-be-annotated training sample set obtained in a case that the traversal of the plurality of sample videos is completed, an annotated training sample set configured for training a frosted glass region detection model, where the annotated training sample set includes frosted glass training samples and frosted glass-free training samples.

A case of obtaining the annotated training sample set in the simulation manner mainly includes the following steps:
acquiring a frosted glass-free training sample annotated with a frosted glass-free region in an annotated training sample set;
performing the frosted glass simulated embedding on the frosted glass-free training sample according to the set embedding position and based on at least one of frosted glass opacity, a text type of a frosted glass region, and an icon type of a frosted glass region, to obtain the simulated frosted glass training sample; and
after the embedding position is used as annotation data of the simulated frosted glass training sample, adding a simulated frosted glass training sample annotated with a frosted glass region to the annotated training sample set.

A process of the supervised training mainly includes the following steps:
performing a prediction on an annotated training sample in an annotated training sample set by using the frosted glass region detection model, to obtain predicted information of each feature point in a feature map of the annotated training sample, where the predicted information of the feature point includes: a predicted position of a predicted candidate box, predicted confidence of whether frosted glass exists in the predicted candidate box, and predicted confidence of whether the predicted candidate box is frosted glass;
obtaining a first class loss, a second class loss, and a third class loss of the annotated training sample based on the predicted information of the feature point in the feature map and annotation data of the annotated training sample, where the first class loss represents a loss between a position of a predicted candidate box and a position of an annotated candidate box, the second class loss represents a loss between predicted confidence that frosted glass exists in a region corresponding to the feature point and annotated confidence and represents a loss between predicted confidence that frosted glass does not exist in a region corresponding to the feature point and actual confidence, and the third class loss represents a loss between predicted confidence of whether frosted glass exists in a region corresponding to the feature point and actual confidence; and
adjusting model parameters of the frosted glass region detection model based on the first class loss, the second class loss, and the third class loss of the annotated training sample in the annotated training sample set, to perform the supervised training on the frosted glass region detection model.

In this embodiment, the model obtained the supervised training is used as an initial model to perform a semi-supervised training, to enhance the detection performance of the frosted glass region detection model.

The semi-supervised training mainly includes the following steps:
acquiring an initial unannotated training sample set, performing a prediction on each unannotated training sample in the initial unannotated training sample set by using an initial model, and determining a pseudo label of the unannotated training sample according to a prediction result, where the pseudo label includes a first label and a second label;
in a case that the prediction result indicates that a quantity of unannotated training samples with the pseudo label being the first label is greater than a quantity of unannotated training samples with the pseudo label being the second label, performing a sampling on the unannotated training samples with the pseudo label being the first label according to the quantity of the unannotated training samples with the pseudo label being the second label, and obtaining an unannotated training sample set according to the unannotated training samples with the pseudo label being the second label and the unannotated training samples with the pseudo label being the first label obtained through the sampling;
performing a prediction on an unannotated training sample in the unannotated training sample set and a corresponding augmented training sample by using the initial model respectively, and acquiring respective prediction results;
sharpening the respective prediction results of the training samples included in the unannotated sample similarity pair, and calculating the consistency loss of the unannotated sample similarity pair according to the sharpened prediction results;
acquiring, according to a prediction result of the annotated training sample by the initial model, predicted confidence of whether a frosted glass region exists in the annotated training sample;
using an annotated training sample with the predicted confidence of whether a frosted glass region exists being less than or equal to a threshold as a target training sample; and
obtaining the joint loss based on the consistency loss of the unannotated sample similarity pair and a labeled training loss of the target training sample; and
performing a joint training on the initial model based on a labeled training loss of an annotated training sample and the consistency loss, to obtain a trained frosted glass region detection model.

In this embodiment, a frame-by-frame detection is performed on a video by using a trained frosted glass region detection model, so that a target video frame that includes a frosted glass region is provided, and a position of the frosted glass region in the target video frame is further provided, to implement high-precision detection of frosted glass. In addition, after a target video frame is obtained, the target video frame is segmented according to consecutiveness of video frames and an overlapping degree of positions of frosted glass regions, to form consecutive target video clips. Overlapping degrees between positions of frosted glass regions in a same video clip are greater than a threshold. In this way, start and stop time of an outputted target video clip in a to-be-detected video may reflect start and stop time of frosted glass regions in the to-be-detected video, and a position of a frosted glass region in the target video clip may reflect a position of frosted glass in the to-be-detected video, thereby improving the precision and recall rate of a frosted glass detection. The related embodiment of the present disclosure may be adequately applied to scenarios such as copyright management, copyright protection, video infringement management, infringement prevention, video security, and copyright security maintenance.

In addition, in this embodiment, the frosted glass region detection model is constructed based on deep learning, and frosted glass regions with various aspect ratios, various sizes, various opacity, and various embedding types in video frames are recognized and learned, and has strong adaptability to variations of frosted glass, and a video frame sequence is detected on a video and results are summarized, so that an excellent and fine effect of recognizing a video frosted glass effect is obtained.

In the aspect of model training, a case of an actual scenario is simulated, so that training samples with a frosted glass effect are simulated as much as possible, to generate simulated frosted glass samples from frosted glass-free samples. In addition, a semi-supervised training framework for a frosted glass detection is further designed for a large number of unknown training samples on the internet. An initial model is jointly trained based on a joint loss obtained from a consistency loss of an unannotated sample similarity pair and a labeled training loss of a target training sample, so that the problem of high acquisition costs of annotated training samples is greatly mitigated. While it is not necessary to continue to add annotated samples, a frosted glass region detection model has a better recognition effect.

In this embodiment, a semi-supervised training framework for a video frame-oriented frosted glass region detection model is constructed, is configured to learn effective information from massive unknown samples on the internet, and includes steps and strategies such as class balancing based on unlabeled training samples of pseudo labels, construction of unannotated sample similarity pairs, consistency prediction training, slow signal release, and sharpening. A pseudo label is obtained based on a prediction result of the initial model, and the class balancing is performed, to avoid overfitting of prediction of a large number of classes by the frosted glass region detection model, thereby improving the detection performance of the frosted glass region detection model. Through the slow signal release strategy, annotated training samples with the predicted confidence greater than the threshold are eliminated to keep the annotated training samples from participating in loss calculation. Errors of the annotated training samples arranged kept from being transferred backward, thereby preventing the overfitting of the part of samples in the training process of the frosted glass region detection model. For the confidence-based masking strategy, unannotated training samples with low predicted confidence are eliminated and are kept from participating in the calculation of the consistency loss. The unannotated training sample is sharpened, which is conducive to the semi-supervised training. The foregoing strategies significantly reduces the dependence of the frosted glass region detection model on annotated training samples, thereby further improving a recognition effect without adding annotated training samples.

It is to be understood that, although the steps are displayed sequentially according to the instructions of the arrows in the flowcharts of the above embodiments, these steps are not necessarily performed sequentially according to the sequence instructed by the arrows. Unless otherwise clearly specified in this specification, the steps are performed without any strict sequence limit, and may be performed in other orders. Besides, at least some steps in the flowchart in the above embodiments may include a plurality of steps or a plurality of stages, the steps or stages are not necessarily performed at a same moment and may be performed at different moments, the steps or stages are not necessarily sequentially performed, and the steps or stages and at least some of other steps or steps or stages of other steps may be performed in turn or alternately.

Based on the same inventive concept, the embodiments of the present disclosure further provide a video detection apparatus configured to implement the foregoing related video detection method. An implementation solution for solving the problem provided in the apparatus is similar to an implementation solution recorded in the foregoing method. Therefore, for specific limitations and technical effects in one or more embodiments of the video detection apparatus provided below, refer to the above limitations and technical effects for the video detection method. Details are not described herein again.

FIG. 19 is a structural block diagram of a video detection apparatus in an embodiment. The video detection apparatus provided in this embodiment may be adequately applied to scenarios such as copyright management, copyright protection, video infringement management, infringement prevention, video security, and copyright security maintenance. With reference to FIG. 19, the apparatus includes:
a video frame acquisition module 1902, configured to acquire a video frame sequence corresponding to a to-be-detected video;
a frosted glass detection module 1904, configured to: sequentially perform a frosted glass detection on each video frame in the video frame sequence by using a trained frosted glass region detection model, and obtain a target video frame that includes a frosted glass region in the video frame sequence and a position of the frosted glass region in the target video frame;
a clustering module 1906, configured to cluster consecutive target video frames in the to-be-detected video according to an overlapping degree between positions of frosted glass regions, to obtain a plurality of consecutive target video clips; and
an output module 1908, configured to output respective start and stop time of the plurality of consecutive target video clips in the to-be-detected video and the positions of the frosted glass regions.

In an embodiment, the video frame acquisition module 1902 is further configured to: acquire the to-be-detected video, and sequentially segment the to-be-detected video according to a frame rate of the to-be-detected video, to obtain a plurality of video segments; perform a sampling on each video segment according to a preset time interval, and acquire a preset quantity of video frames; and obtain a video frame sequence based on the preset quantity of video frames obtained from each video segment.

In an embodiment, the frosted glass detection module 1904 is further configured to: sequentially input each video frame in the video frame sequence into the trained frosted glass region detection model; extract a feature map corresponding to the video frame by using a feature extraction network of the frosted glass region detection model; and obtain a class and a confidence of each feature point in the feature map by using a frosted glass classification network of the frosted glass region detection model and based on the feature map of the video frame.

In an embodiment, the frosted glass detection module 1904 is further configured to: acquire the class and the confidence of each feature point in the feature map outputted by the frosted glass classification network; determine a frosted glass region detection result of the video frame based on confidence that a region corresponding to each feature point in the feature map is a frosted glass region and a predicted position of a predicted candidate box corresponding to each feature point, where the frosted glass region detection result includes whether a frosted glass region exists in the video frame and a position of the frosted glass region; and obtain, according to the frosted glass region detection result of the video frame in the video frame sequence, the target video frame in which the frosted glass region exists in the video frame sequence and the position of the frosted glass region in the target video frame.

In an embodiment, the video detection apparatus further includes: an annotated training set acquisition module, configured to acquire an annotated training sample set configured for training a frosted glass region detection model; a hyperparameter determining module, configured to: determine, according to annotation data of each annotated training sample in the annotated training sample set, aspect ratios of frosted glass regions in the annotated training sample; and cluster the aspect ratios of the frosted glass regions in the annotated training sample, to obtain a plurality of cluster centers; and a supervised training module, configured to: after the aspect ratios represented by the cluster centers are used as hyperparameters for training the frosted glass region detection model, perform a supervised training on the frosted glass region detection model by using the annotated training sample.

In an embodiment, the annotated training set acquisition module included in the video detection apparatus is further configured to: acquire a plurality of sample videos; for each sample video, start a traversal from the first video frame in the sample video, in a case that a current video frame is not similar to an adjacent video frame, add the current video frame to a to-be-annotated training sample set, and in a case that a current video frame is similar to an adjacent video frame, skip the current video frame, until the traversal of the video frames in the sample video ends; obtain, based on a to-be-annotated training sample set obtained in a case that the traversal of the plurality of sample videos is completed, an annotated training sample set configured for training a frosted glass region detection model.

In an embodiment, the annotated training set acquisition module included in the video detection apparatus is further configured to: acquire a frosted glass-free training sample annotated with a frosted glass-free region in an annotated training sample set; perform a frosted glass simulated embedding on the frosted glass-free training sample according to a set embedding position, to obtain a simulated frosted glass training sample; and after the embedding position is used as annotation data of the simulated frosted glass training sample, add a simulated frosted glass training sample annotated with a frosted glass region to the annotated training sample set.

In an embodiment, the video detection apparatus further includes a simulated embedding module, configured to perform the frosted glass simulated embedding on the frosted glass-free training sample according to the set embedding position and based on at least one of frosted glass opacity, a text type of a frosted glass region, and an icon type of a frosted glass region, to obtain the simulated frosted glass training sample; and

In an embodiment, the supervised training module included in the video detection apparatus is configured to: perform a prediction on an annotated training sample in an annotated training sample set by using the frosted glass region detection model, to obtain predicted information of each feature point in a feature map of the annotated training sample, where the predicted information of the feature point includes: a predicted position of a predicted candidate box, predicted confidence of whether frosted glass exists in the predicted candidate box, and predicted confidence of whether the predicted candidate box is frosted glass; obtain a first class loss, a second class loss, and a third class loss of the annotated training sample based on the predicted information of the feature point in the feature map and annotation data of the annotated training sample, where the first class loss represents a loss between a position of a predicted candidate box and a position of an annotated candidate box, the second class loss represents a loss between predicted confidence that frosted glass exists in a region corresponding to the feature point and annotated confidence and represents a loss between predicted confidence that frosted glass does not exist in a region corresponding to the feature point and actual confidence, and the third class loss represents a loss between predicted confidence of whether frosted glass exists in a region corresponding to the feature point and actual confidence; and adjust model parameters of the frosted glass region detection model based on the first class loss, the second class loss, and the third class loss of the annotated training sample in the annotated training sample set, to perform the supervised training on the frosted glass region detection model.

In an embodiment, the video detection apparatus further includes: an unannotated training set processing module, configured to: acquire an unannotated training sample set, perform a data augmentation on an unannotated training sample in the unannotated training sample set, and obtain an unannotated sample similarity pair based on the unannotated training sample and the augmented training sample; use a frosted glass region detection model obtained by performing a supervised training by using an annotated training sample set as an initial model, perform a prediction on the training samples included in the unannotated sample similarity pair respectively by using the initial model, and acquire respective prediction results of the training samples included in the unannotated sample similarity pair; an unlabeled loss acquisition module, configured to obtain a consistency loss of the unannotated sample similarity pair based on a difference between the respective prediction results of the training samples included in the unannotated sample similarity pair; and a joint training module, configured to: obtain a joint loss based on the consistency loss of the unannotated sample similarity pair and a labeled training loss of an annotated training sample, and adjust model parameters of the initial model by using the joint loss, to obtain the trained frosted glass region detection model.

In an embodiment, the unannotated training set processing module is configured to: acquire an initial unannotated training sample set, perform a prediction on each unannotated training sample in the initial unannotated training sample set by using an initial model, and determine a pseudo label of the unannotated training sample according to a prediction result, where the pseudo label includes a first label and a second label; and in a case that the prediction result indicates that a quantity of unannotated training samples with the pseudo label being the first label is greater than a quantity of unannotated training samples with the pseudo label being the second label, perform a sampling on the unannotated training samples with the pseudo label being the first label according to the quantity of the unannotated training samples with the pseudo label being the second label, and obtain an unannotated training sample set according to the unannotated training samples with the pseudo label being the second label and the unannotated training samples with the pseudo label being the first label obtained through the sampling.

In an embodiment, the joint training module is further configured to: acquire, according to a prediction result of the annotated training sample by the initial model, predicted confidence of whether a frosted glass region exists in the annotated training sample; use an annotated training sample with the predicted confidence of whether a frosted glass region exists being less than or equal to a threshold as a target training sample; and obtain the joint loss based on the consistency loss of the unannotated sample similarity pair and a labeled training loss of the target training sample.

In an embodiment, the unlabeled loss acquisition module is configured to: sharpen the respective prediction results of the training samples included in the unannotated sample similarity pair, and calculate the consistency loss of the unannotated sample similarity pair according to the sharpened prediction results.

In an embodiment, the unlabeled loss acquisition module is further configured to: in a case that predicted confidence in the prediction results of the training samples included in the unannotated sample similarity pair is greater than a threshold, keep the unannotated sample similarity pair to participate in the calculation of the consistency loss; and when the predicted confidence in the prediction results of the training samples included in the unannotated sample similarity pair is less than the threshold, eliminate the unannotated sample similarity pair to keep the unannotated sample similarity pair from participating in the calculation of the consistency loss.

In an embodiment, the video detection apparatus further includes a consecutiveness determining module, configured to: acquire any two target video frames; and in a case that a difference between display time corresponding to the any two target video frames is less than or equal to a threshold, determine that the any two target video frames are consecutive target video frames.

In an embodiment, the video detection apparatus further includes an overlapping degree acquisition module, configured to: acquire a ratio of an intersection area to a union area of the frosted glass regions of the consecutive target video frames; and use the ratio as the overlapping degree between the positions of the frosted glass regions in the consecutive target video frames.

In the foregoing video detection apparatus, a frame-by-frame detection is performed on a video by using a trained frosted glass region detection model, so that a target video frame that includes a frosted glass region is provided, and a position of the frosted glass region in the target video frame is further provided, to implement high-precision detection of frosted glass. In addition, after a target video frame is obtained, the target video frame is segmented according to consecutiveness of video frames and an overlapping degree of positions of frosted glass regions, to form consecutive target video clips. Overlapping degrees between positions of frosted glass regions in a same video clip are greater than a threshold. In this way, start and stop time of an outputted target video clip in a to-be-detected video may reflect start and stop time of frosted glass regions in the to-be-detected video, and a position of a frosted glass region in the target video clip may reflect a position of frosted glass in the to-be-detected video, thereby improving the precision of a frosted glass detection. The apparatus may be adequately applied to scenarios such as copyright management, copyright protection, video infringement management, infringement prevention, video security, and copyright security maintenance.

The modules in the foregoing video detection apparatus may be implemented entirely or partially by software, hardware, or a combination thereof. The foregoing modules may be built in or independent of a processor of a computer device in a hardware form, or may be stored in a memory of the computer device in a software form, so that the processor invokes and performs an operation corresponding to each of the foregoing modules. Further, each module can be part of an overall module that includes the functionalities of the module.

Based on the same inventive concept, the embodiments of the present disclosure further provide an apparatus for training a frosted glass region detection model configured to implement the foregoing related method for training a frosted glass region detection model. An implementation solution for solving the problem provided in the apparatus is similar to an implementation solution recorded in the foregoing method. Therefore, for specific limitations and technical effects in one or more embodiments of the apparatus for training a frosted glass region detection model provided below, refer to the above limitations and technical effects for the method for training a frosted glass region detection mode. Details are not described herein again.

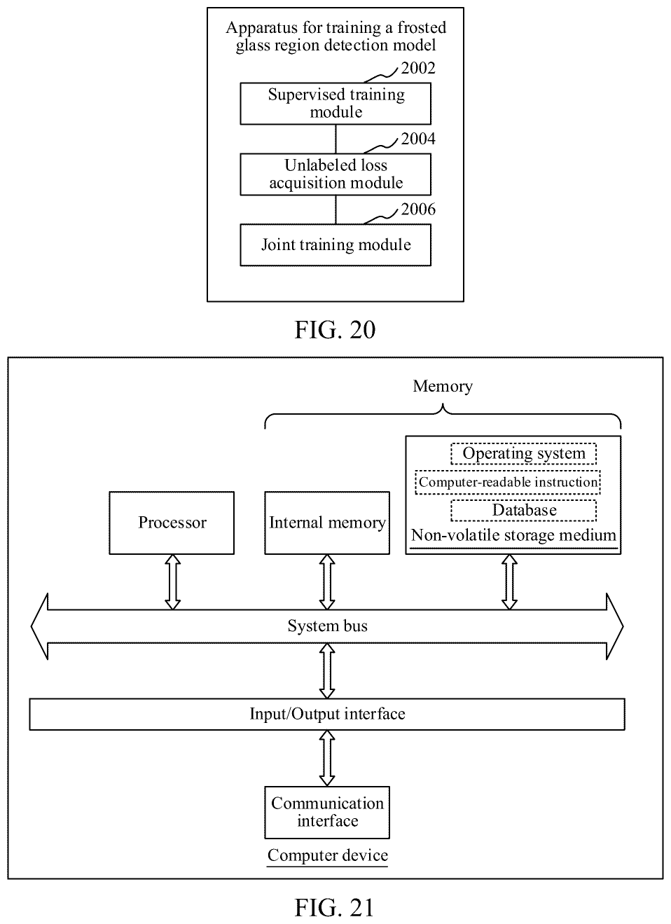

FIG. 20 is a structural block diagram of an apparatus for training a frosted glass region detection model in an embodiment. The apparatus for training a frosted glass region detection model provided in this embodiment may be adequately applied to scenarios such as copyright management, copyright protection, video infringement management, infringement prevention, video security, and copyright security maintenance. With reference to FIG. 20, the apparatus includes:
a supervised training module 2002, configured to perform a supervised training on a frosted glass region detection model by using an annotated training sample set to obtain an initial model;
an unlabeled loss acquisition module 2004, configured to: acquire an unannotated training sample set, perform a prediction on an unannotated training sample in the unannotated training sample set and a corresponding augmented training sample by using the initial model respectively, acquire respective prediction results, and obtain a consistency loss based on a difference between the respective prediction results of the unannotated training sample and the corresponding augmented training sample; and
a joint training module 2006, configured to perform a joint training on the initial model based on a labeled training loss of an annotated training sample and the consistency loss, to obtain a trained frosted glass region detection model.

In the foregoing apparatus for training a frosted glass region detection model, a supervised training is first performed on a frosted glass region detection model, an unannotated training sample set is predicted based on an initial model obtained through the supervised training, to obtain a consistency loss between an unannotated training sample and a corresponding augmented training sample, and the initial model is jointly trained based on a labeled training loss of an annotated training sample and the consistency loss, so that while annotation costs can be reduced, the detection performance of the frosted glass region detection model is enhanced. The apparatus may be adequately applied to scenarios such as copyright management, copyright protection, video infringement management, infringement prevention, video security, and copyright security maintenance.

The modules in the foregoing apparatus for training a frosted glass region detection model may be implemented entirely or partially by software, hardware, or a combination thereof. The foregoing modules may be built in or independent of a processor of a computer device in a hardware form, or may be stored in a memory of the computer device in a software form, so that the processor invokes and performs an operation corresponding to each of the foregoing modules.

In an embodiment, a computer device is provided. The computer device may be a terminal or a server, and an internal structure diagram thereof may be shown in FIG. 21. The computer device includes a processor, a memory, an input/output (I/O) interface, and a communication interface that are connected by a system bus. The processor, the memory, and the input/output interface are connected by a system bus. The communication interface is connected to the system bus by the input/output interface. The processor of the computer device is configured to provide computing and control capabilities. The memory of the computer device includes a non-volatile storage medium and an internal memory. The non-volatile storage medium stores an operating system, computer-readable instructions, and a database. The internal memory provides an environment for running of the operating system and the computer-readable instructions in the non-volatile storage medium. The database of the computer device is configured to store data in the foregoing embodiments. The input/output interface of the computer device is configured to exchange information between the processor and an external device. The communication interface of the computer device is configured to communicate with an external terminal through a network connection. When executed by a processor, the computer-readable instructions implement the method described in the foregoing embodiments.

A person skilled in the art may understand that the structures shown in the block diagram of FIG. 21 are only a partial structure related to a solution in the present disclosure, and the figures do not constitute a limitation to the computer device to which the solution in the present disclosure is applied. Specifically, the computer device may include more components or fewer components than those shown in the figures, or some components may be combined, or a different component deployment may be used.

In an embodiment, a computer device is provided, and includes a memory and a processor, the memory storing computer-readable instructions, when executed by the processor, the computer-readable instructions implementing the steps in the foregoing method embodiments.

In an embodiment, a computer-readable storage medium is further provided, having computer-readable instructions stored therein thereon, when executed by a processor, the computer-readable instructions implementing the steps in the foregoing method embodiments.

In an embodiment, a computer program product is provided, including computer-readable instructions, when executed by a processor, the computer-readable instructions implementing the steps in the foregoing method embodiments.

User information (including, but not limited to, device information of a user, and personal information of a user) and data (including, but not limited to, data for analysis, stored data, and displayed data) in the present disclosure are all information and data authorized by a user or fully authorized by all parties, and the collection, use and processing of relevant data need to comply with the relevant laws, regulations, and standards of the relevant countries and regions.

A person of ordinary skill in the art may understand that all or some of the processes of the methods in the foregoing embodiments may be implemented by computer-readable instructions instructing relevant hardware. The computer-readable instructions may be stored in a non-volatile computer-readable storage medium. When the computer-readable instructions run, the procedures of the foregoing method embodiments are performed. References to the memory, the database, or other medium used in the embodiments provided in the present disclosure may all include at least one of a non-volatile and a volatile memory. The non-volatile memory may include a read-only memory (ROM), a magnetic tape, a floppy disk, a flash, an optical memory, a high-density embedded non-volatile memory, a rheostat memory (ReRAM), a magnetoresistive random access memory (MRAM), a ferroelectric random access memory (FRAM), a phase change memory (PCM), a graphene memory, or the like. The volatile memory may include a random access memory (RAM) or a cache. By way of description rather than limitation, the RAM may be obtained in a plurality of forms, for example, a static random access memory (SRAM) or a dynamic random access memory (DRAM). The database in the embodiments provided in the present disclosure may include at least one of a relational database and a non-relational database. The non-relational database may include a blockchain-based distributed database, or the like, but is not limited thereto. The processor in the embodiments provided in the present disclosure may be a general-purpose processor, a central processing unit, a graphic processing unit, a digital signal processor, a programmable logic device, a quantum computation-based data processing logic device, or the like, but is not limited thereto.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this specification provided that no conflict exists.

The foregoing embodiments only show several implementations of the present disclosure and are described in detail, but they are not to be construed as a limitation to the patent scope of the present disclosure. A person of ordinary skill in the art may make various changes and improvements without departing from the ideas of the present disclosure, which shall all fall within the protection scope of the present disclosure. Therefore, the protection scope of the present disclosure shall be subject to the appended claims.

What is claimed is:

1. A video detection method, performed by a computer device, the method comprising:
acquiring a video frame sequence corresponding to a target video;
sequentially performing a frosted glass detection on a plurality of video frames in the video frame sequence by using a trained frosted glass region detection model, and obtaining a target video frame that includes a frosted glass region in the video frame sequence and a position of the frosted glass region in the target video frame;
clustering consecutive target video frames in the target video according to an overlapping degree between positions of frosted glass regions, to obtain a plurality of consecutive target video clips; and
outputting respective start and stop time of the plurality of consecutive target video clips in the target video and the positions of the frosted glass regions.

2. The method according to claim 1, wherein the acquiring a video frame sequence corresponding to a target video comprises:
acquiring the target video, and sequentially segmenting the target video according to a frame rate of the target video, to obtain a plurality of video segments;
performing a sampling on each video segment of the plurality of video segments according to a preset time interval, and acquiring a preset quantity of video frames; and
obtaining the video frame sequence based on the preset quantity of video frames obtained from each video segment.

3. The method according to claim 1, wherein the sequentially performing a frosted glass detection on a plurality of video frames in the video frame sequence by using a trained frosted glass region detection model comprises:
sequentially inputting each video frame of the plurality of video frames in the video frame sequence into the trained frosted glass region detection model;
extracting a feature map corresponding to the video frame by using a feature extraction network of the frosted glass region detection model; and
obtaining a class and a confidence of each feature point in the feature map by using a frosted glass classification network of the frosted glass region detection model and based on the feature map of the video frame.

4. The method according to claim 3, wherein the obtaining a target video frame that includes a frosted glass region in the video frame sequence and a position of the frosted glass region in the target video frame comprises:
acquiring the class and the confidence of each feature point in the feature map outputted by the frosted glass classification network;
determining a frosted glass region detection result of the video frame based on the confidence that a region corresponding to each feature point in the feature map is a frosted glass region and a predicted position of a predicted candidate box corresponding to each feature point, wherein the frosted glass region detection result comprises whether the video frame includes a frosted glass region exists and a position of the frosted glass region when the video frame includes the frosted glass region; and
obtaining, according to the frosted glass region detection result of the video frame in the video frame sequence, the target video frame in which the frosted glass region exists in the video frame sequence and the position of the frosted glass region in the target video frame.

5. The method according to claim 1, wherein the method further comprises:
acquiring an annotated training sample set configured for training the frosted glass region detection model;
determining, according to annotation data of each annotated training sample in the annotated training sample set, aspect ratios of frosted glass regions in the annotated training sample;
clustering the aspect ratios of the frosted glass regions in the annotated training sample, to obtain a plurality of cluster centers; and
after the aspect ratios represented by the cluster centers are used as hyperparameters for training the frosted glass region detection model, performing a supervised training on the frosted glass region detection model by using the annotated training sample.

6. The method according to claim 1, wherein operations of acquiring an annotated training sample configured for training the frosted glass region detection model comprise:
acquiring a plurality of sample videos;
for each sample video, starting a traversal from a first video frame in the sample video, in a case that a current video frame is not similar to an adjacent video frame, adding the current video frame to a training sample set to be annotated, and in a case that a current video frame is similar to an adjacent video frame, skipping the current video frame, until the traversal of the video frames in the sample video ends; and
obtaining, based on the training sample set obtained in a case that the traversal of the plurality of sample videos is completed, the annotated training sample set configured for training the frosted glass region detection model.

7. The method according to claim 1, wherein operations of acquiring an annotated training sample configured for training the frosted glass region detection model comprise:
acquiring a frosted glass-free training sample annotated with a frosted glass-free region in an annotated training sample set;
performing a frosted glass simulated embedding on the frosted glass-free training sample according to a set embedding position, to obtain a simulated frosted glass training sample; and
after the embedding position is used as annotation data of the simulated frosted glass training sample, adding a simulated frosted glass training sample annotated with a frosted glass region to the annotated training sample set.

8. The method according to claim 7, wherein the performing a frosted glass simulated embedding on the frosted glass-free training sample according to a set embedding position, to obtain a simulated frosted glass training sample comprises:
performing the frosted glass simulated embedding on the frosted glass-free training sample according to the set embedding position and based on at least one of frosted glass opacity, a text type of a frosted glass region, or an icon type of a frosted glass region, to obtain the simulated frosted glass training sample.

9. The method according to claim 1, wherein operations of a supervised training of a frosted glass region detection model comprise:
performing a prediction on an annotated training sample in an annotated training sample set by using the frosted glass region detection model, to obtain predicted information of each feature point in a feature map of the annotated training sample, wherein the predicted information of the feature point comprises: a predicted position of a predicted candidate box, predicted confidence of whether frosted glass exists in the predicted candidate box, and predicted confidence of whether the predicted candidate box is frosted glass;
obtaining a first class loss, a second class loss, and a third class loss of the annotated training sample based on the predicted information of the feature point in the feature map and annotation data of the annotated training sample, wherein the first class loss represents a loss between a position of a predicted candidate box and a position of an annotated candidate box, the second class loss represents a loss between predicted confidence that frosted glass exists in a region corresponding to the feature point and annotated confidence and represents a loss between predicted confidence that frosted glass does not exist in a region corresponding to the feature point and actual confidence, and the third class loss represents a loss between predicted confidence of whether frosted glass exists in a region corresponding to the feature point and actual confidence; and
adjusting model parameters of the frosted glass region detection model based on the first class loss, the second class loss, and the third class loss of the annotated training sample in the annotated training sample set, to perform the supervised training on the frosted glass region detection model.

10. The method according to claim 1, wherein the method further comprises:
acquiring an unannotated training sample set, performing a data augmentation on an unannotated training sample in the unannotated training sample set, and obtaining an unannotated sample similarity pair based on the unannotated training sample and the augmented training sample;
using a frosted glass region detection model obtained by performing a supervised training by using an annotated training sample set as an initial model, performing a prediction on the training samples comprised in the unannotated sample similarity pair respectively by using the initial model, and acquiring respective prediction results of the training samples comprised in the unannotated sample similarity pair;
obtaining a consistency loss of the unannotated sample similarity pair based on a difference between the respective prediction results of the training samples comprised in the unannotated sample similarity pair; and
obtaining a joint loss based on the consistency loss of the unannotated sample similarity pair and a labeled training loss of an annotated training sample, and adjusting model parameters of the initial model by using the joint loss, to obtain the trained frosted glass region detection model.

11. The method according to claim 10, wherein the acquiring an unannotated training sample set comprises:
acquiring an initial unannotated training sample set, performing a prediction on each unannotated training sample in the initial unannotated training sample set by using the initial model, and determining a pseudo label of the unannotated training sample according to a prediction result, wherein the pseudo label is one of a first label and a second label; and
in a case that the prediction result indicates that a quantity of unannotated training samples with the pseudo label being the first label is greater than a quantity of unannotated training samples with the pseudo label being the second label, performing a sampling on the unannotated training samples with the first label according to the quantity of the unannotated training samples with the second label, and obtaining the unannotated training sample set according to the unannotated training samples with the second label and the unannotated training samples with the first label obtained after the sampling.

12. The method according to claim 10, wherein the obtaining a joint loss based on the consistency loss of the unannotated sample similarity pair and a labeled training loss of an annotated training sample comprises:
acquiring, according to a prediction result of the annotated training sample by the initial model, predicted confidence of whether a frosted glass region exists in the annotated training sample;
using an annotated training sample with the predicted confidence being less than or equal to a threshold as a target training sample; and
obtaining the joint loss based on the consistency loss of the unannotated sample similarity pair and a labeled training loss of the target training sample.

13. The method according to claim 10, wherein the obtaining a consistency loss of the unannotated sample similarity pair based on a difference between the respective prediction results of the training samples comprised in the unannotated sample similarity pair comprises:
sharpening the respective prediction results of the training samples comprised in the unannotated sample similarity pair, and calculating the consistency loss of the unannotated sample similarity pair according to the sharpened prediction results.

14. The method according to claim 13, wherein the sharpening the respective prediction results of the training samples comprised in the unannotated sample similarity pair comprises:
in a case that predicted confidence in the prediction results of the training samples comprised in the unannotated sample similarity pair is greater than a threshold, keeping the unannotated sample similarity pair to participate in the calculation of the consistency loss; and
when the predicted confidence in the prediction results of the training samples comprised in the unannotated sample similarity pair is less than the threshold, eliminating the unannotated sample similarity pair to keep the unannotated sample similarity pair from participating in the calculation of the consistency loss.

15. The method according to claim 1, further comprising:
acquiring two target video frames; and
in a case that a difference between display time corresponding to the two target video frames is less than or equal to a threshold, determining that the two target video frames are consecutive target video frames.

16. The method according to claim 1, further comprising:
acquiring a ratio of an intersection area to a union area of the frosted glass regions of the consecutive target video frames; and
using the ratio as the overlapping degree between the positions of the frosted glass regions in the consecutive target video frames.

17. The method according to claim 1, wherein the frosted glass region detection model is trained by:
performing a supervised training on a frosted glass region detection model by using an annotated training sample set to obtain an initial model;
acquiring an unannotated training sample set, performing a prediction on an unannotated training sample in the unannotated training sample set and a corresponding augmented training sample by using the initial model respectively, acquiring respective prediction results, and obtaining a consistency loss based on a difference between the respective prediction results of the unannotated training sample and the corresponding augmented training sample; and
performing a joint training on the initial model based on a labeled training loss of an annotated training sample and the consistency loss, to obtain a trained frosted glass region detection model.

18. A video detection apparatus, the apparatus comprising:
at least one memory and at least one processor, the at least one memory storing computer-readable instructions, when executed by the at least one processor, the computer-readable instructions implementing:
acquiring a video frame sequence corresponding to a target video;
sequentially performing a frosted glass detection on a plurality of video frames in the video frame sequence by using a trained frosted glass region detection model, and obtaining a target video frame that includes a frosted glass region in the video frame sequence and a position of the frosted glass region in the target video frame;
clustering consecutive target video frames in the target video according to an overlapping degree between positions of frosted glass regions, to obtain a plurality of consecutive target video clips; and
outputting respective start and stop time of the plurality of consecutive target video clips in the target video and the positions of the frosted glass regions.

19. The apparatus according to claim 18, wherein the sequentially performing a frosted glass detection on a plurality of video frames in the video frame sequence by using a trained frosted glass region detection model comprises:
sequentially inputting each video frame of the plurality of video frames in the video frame sequence into the trained frosted glass region detection model;
extracting a feature map corresponding to the video frame by using a feature extraction network of the frosted glass region detection model; and
obtaining a class and a confidence of each feature point in the feature map by using a frosted glass classification network of the frosted glass region detection model and based on the feature map of the video frame.

20. A non-transitory computer-readable storage medium, having computer-readable instructions stored therein, when executed by at least one processor, causing the at least one processor to implement:
acquiring a video frame sequence corresponding to a target video;
sequentially performing a frosted glass detection on a plurality of video frames in the video frame sequence by using a trained frosted glass region detection model, and obtaining a target video frame that includes a frosted glass region in the video frame sequence and a position of the frosted glass region in the target video frame;
clustering consecutive target video frames in the target video according to an overlapping degree between positions of frosted glass regions, to obtain a plurality of consecutive target video clips; and
outputting respective start and stop time of the plurality of consecutive target video clips in the target video and the positions of the frosted glass regions.
